(19) United States
(12) Patent Application Publication
(10) Pub. No.: US 2009/0146961 A1
(43) Pub. Date: Jun. 11, 2009

(54) DIGITAL IMAGE EDITING INTERFACE

(76) Inventors: David Shun-Chi Cheung, Calgary (CA); Wai Quin Cheung, Calgary (CA)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/951,326

(22) Filed: Dec. 5, 2007

(51) Int. Cl. G06F 3/02

(52) U.S. Cl. 345/172

(57) ABSTRACT

A digital image editing system includes a keyboard with keys each mapped to a digital image editing operation encoded by one or more digital image editing application macros and scripts. Keys that are mapped to digital image editing operations that are related to one another are located adjacent to one another. The keyboard is adapted for the use of a user's non-dominant hand, allowing the user's dominant hand to manipulate a cursor controlling device, such as a computer mouse, without switching back and forth between the keyboard and cursor controlling device. Macros and scripts have been developed to reduce the number of user commands, such as keystrokes and cursor events, required to perform a digital image editing operation.

### FIELD OF THE INVENTION

The present invention relates generally to the field of information and data processing. More particularly, the invention relates to digital image editing, and tools for digital image editing.

### BACKGROUND

There are numerous problems with the conventional tools for digital image editing. Before detailing the problems, it is first necessary to provide some background on digital image editing. Digital image editing involves the altering of a digital image, typically using a digital image editing application such as Adobe™ Photoshop™ 7, Adobe Photoshop CS2 (Creative Suite™ 2), Adobe Photoshop CS3 (Creative Suite 3), Adobe Bridge, Adobe Camera Raw, Phase One's Capture One, or Adobe Lightroom. A digital image editing operation (hereafter “editing operation”) includes, but is not limited to brightening an image, darkening a portion of an image, and magnifying a portion of an image, which are a few examples out of many possible editing operations.

To execute an editing operation, a user must often perform a sequence of user commands, which include keystrokes and cursor events. Cursor events include cursor display selections, cursor movements, and cursor intensity selections using a cursor controlling device. A cursor controlling device includes, but is not limited to a computer mouse (hereafter “mouse”), joy stick, game controller, touchpad, and pen and tablet.

A cursor display selection involves using the cursor to perform a selection on the display, for example selecting a toolbar or menu option with the cursor. One way to perform a cursor display selection is by depressing a button on a mouse, while another way is by touching the touchpad surface.

Cursor movement involves moving the cursor, for example moving the cursor over a digital image. One way to perform cursor movement is by translating the mouse over a surface, while another way is translating a finger over the touchpad surface.

Cursor intensity selection involves selecting the intensity at which to perform a drawing action in a digital image editing application. For example, the pressure applied to the pen tip of a pen and tablet cursor controlling device can control the width at which a line is drawn.

When performing an editing operation, a user must often perform a sequence of user commands. If the user performs the same editing operation at a later time, the user may iterate through the same sequence of user commands, which would be repetitive. For example, to increase the brush size in Photoshop, a user may perform the following sequence of cursor events: position the cursor over the Tools tab on the toolbar, select the brush tool, position the cursor over the brush properties box, select the brush properties box, position the cursor over the Master Diameter slider, drag Master Diameter slider to create desired brush size. Alternatively, an experienced user may press the right bracket (“]”) key to increase the brush size. A sequence of user commands which performs the same operation as a typically longer sequence of user commands is called a macro. However, a sequence of user commands which performs the same operation as an equal length or shorter sequence of user commands may also be called a macro.

A macro that consists of a sequence of user commands with only keystrokes and no cursor events is commonly called a keyboard shortcut or hotkey. To be specific, the sequence of keystrokes may consist of some keys being held while others are pressed. Take for example the sequence of keystrokes <Ctrl><Alt><Delete>, in which each key that is pressed is held until the entire sequence has been performed. In the example given above, a right bracket (“]”) keystroke is a keyboard shortcut for increasing the brush size in Photoshop.

Macros are called actions in Photoshop. There are Photoshop actions, which are actions provided by Photoshop, and custom actions, which are not provided by Photoshop. For example, there is no Photoshop action to edit the properties of a layer, which groups the changes from one editing operation together. The user may create a custom action, by recording the sequence of user commands to open the Layer Properties Dialog Box, and assigning that sequence of user commands to a typically shorter sequence of user commands. Alternatively, the user may create a custom keyboard shortcut, by assigning the sequence of user commands which opens the Layer Properties Dialog Box to a sequence of only keystrokes.

There are certain editing operations for which macros and actions cannot be created. These are editing operations which involve variables (or unknowns) and conditions. For example, it is possible to create an action to re-size an image to have the dimensions of a particular placeholder (e.g. square, rectangle, or other shape), and position the image in the placeholder, where the placeholder is of a particular dimension, at a particular location. However, it is not possible to create an action to re-size an image to have the dimension of a placeholder of any dimension, and position the image in a placeholder at any location. For example, it is also not possible to create an action which resizes any image larger than 4 in.×6 in. to be 4 in.×6 in., while leaving images smaller than 4 in.×6 in. unchanged. Encoding an editing operation which involves variables and conditions requires a script, which is a type of computer program. A script may be assigned to a sequence of keystrokes, creating another type of keyboard shortcut.

While Photoshop and other digital image editing applications have provided some improvements to digital image editing tools, numerous deficiencies still exist. First, users still are forced to perform many repeated sequences of user commands. For example, when editing many images, a user must open, save, and close each image. The repeated sequence of user commands may initially not be apparent in this example. With more thought, one may realize a repeated sequence of operations if a user were to open, save, and close a first image; open save, and close a second image; and repeat this procedure with other images, where the open, save and close were performed sequentially. Opening, saving, and closing an image may be three operations, but each operation might involve multiple keystrokes and cursor events. The number of user commands associated with opening, saving, and closing an image multiplied by thousands of images, consumes a lot of time which could have been used for editing images. Unfortunately, conventional digital image editing applications do not provide macros or scripts to minimize many repeated sequences of user commands, only one of which has been illustrated above.

Conventional systems with a QWERTY keyboard and cursor controlling device are designed for word processing, not digital image editing. For word processing, the QWERTY keyboard is the primary input device, allowing a user to enter alpha-numeric symbols, and the cursor controlling device is the secondary input device, allowing the user to occasionally select text and navigate to different pages of text. The use of the QWERTY keyboard and cursor controlling device are very different for digital image editing, where an image and not text is manipulated. The role of the cursor controlling device is much more important, enabling a user to paint changes onto an image, select portions of the image, and perform other editing operations. The user may spend more time manipulating the cursor controlling device than the time on the QWERTY keyboard. Instead of inputting alpha-numeric symbols, the QWERTY keyboard's primary use is for performing keyboard shortcuts.

While a keyboard shortcut is one example of adapting the conventional keyboard for image editing, these adaptations still have deficiencies. The keyboard shortcut <Ctrl><Alt><Shift> L, for the Auto Contrast Action in Photoshop, illustrates some of the deficiencies. Pressing <Ctrl><Alt><Shift> L requires the use of two hands. Two handed use of the QWERTY keyboard stops the user from manipulating the cursor controlling device and performing free-handed operations. <Ctrl><Alt<Shift> L is difficult to press, requiring four held keys, as well as difficult to remember.

Lastly, image editing keyboard shortcuts are arranged on a QWERTY keyboard with little functional relationship. Instead, operations have been assigned to keys for mnemonic reasons. For example in Photoshop, the Gradient Tool has been assigned to the G key and the Hand Tool has been assigned to the H key. As the Gradient Tool is used to mix colors and the Hand Tool is used to view different sections of an image, the Gradient and Hand Tools illustrate that keys which are located close to each other on a conventional keyboard (the G & H keys are adjacent to each other on a QWERTY keyboard) are not necessarily related by their editing operations. The layout of the key labels on a QWERTY keyboard is merely a vestige from word processing and serves little function for digital image editing.

### SUMMARY OF THE INVENTION

According to one aspect of the present invention, there is provided a keyboard which has keys each mapped to a digital image editing operation encoded by one or more digital image editing application macros or scripts. The keys are arranged so that (i) those of the keys that are mapped to digital image editing operations that are related to one another are located adjacent to one another, and (ii) the entire plurality of keys is distributed across the keyboard so as to be manipulable by a single, non-dominant hand of a user.

According to one aspect of the present invention, there is provided a system which has a computing device and a digital image editing keyboard interfaced with the computing device. The keyboard includes keys each mapped to a digital image editing operation encoded by one or more digital image editing application macros or scripts. The keys are arranged so that (i) those of the keys that are mapped to digital image editing operations that are related to one another are located adjacent to one another, and (ii) the entire plurality of keys is distributed across the keyboard so as to be manipulable by a single, non-dominant hand of a user.

According to one aspect of the present invention, there is provided a system which has a multi-user computing device and a digital image editing keyboard interfaced with the multi-user computing device. The keyboard includes keys each mapped to a digital image editing operation encoded by one or more digital image editing application macros or scripts. The keys are arranged so that (i) those of the keys that are mapped to digital image editing operations that are related to one another are located adjacent to one another, and (ii) the entire plurality of keys is distributed across the keyboard so as to be manipulable by a single, non-dominant hand of a user.

According to one aspect of the present invention, there is provided a digital image editing interface which has a plurality of human manipulable components each mapped to a digital image editing operation encoded by at least one of a digital image editing application macro or script. The human manipulable components are arranged so that those of the human manipulable components that are mapped to digital image editing operations that are related to one another are located adjacent to one another.

According to one aspect of the present invention, there is provided a system with a computing device and a digital image editing interface interfaced with the computing device. The digital image editing interface includes a plurality of human manipulable components each mapped to a digital image editing operation encoded by at least one of a digital image editing application macro or script. The human manipulable components are arranged so that those of the human manipulable components that are mapped to digital image editing operations that are related to one another are located adjacent to one another.

According to one aspect of the present invention, there is provided a system with a multi-user computing device and a digital image editing interface interfaced with the multi-user computing device. The digital image editing interface includes a plurality of human manipulable components each mapped to a digital image editing operation encoded by at least one of a digital image editing application macro or script. The human manipulable components are arranged so that those of the human manipulable components that are mapped to digital image editing operations that are related to one another are located adjacent to one another.

Other aspects of the invention are described below and in connection with the description of the figures that follow.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1A shows a block diagram of a digital image editing system, according to an embodiment of the invention;

FIG. 1B depicts a digital image editing keyboard configured with one layer of key mappings, according to an embodiment of the invention;

FIG. 1C depicts a digital image editing keyboard configured with three layers of key mappings, according to an embodiment of the invention;

FIG. 2A depicts the Photoshop Curves Dialog Box with a linear tonality curve;

FIG. 2B depicts the Curves Dialog Box with a tonality curve with three added anchor points;

FIG. 2C depicts the Curves Dialog Box with a tonality curve that has been adjusted to achieve a desired contrast adjustment;

FIG. 2D depicts an example S curve with two added anchor points, according to an embodiment of the invention;

FIG. 2E-2F depict an example mask and resulting image, according to an embodiment of the invention;

FIG. 2G shows a Burn tonality curve with one added anchor point, according to an embodiment of the invention;

FIG. 2H shows a Dodge tonality curve with one added anchor point, according to an embodiment of the invention;

FIG. 3A shows a flow diagram of the configuration routine of the AutoLoader tool, according to an embodiment of the invention;

FIG. 3B shows a flow diagram of a method to use the AutoLoader key, according to an embodiment of the invention;

FIG. 3C shows a block diagram of a system configured for the AutoLoader operation, according to an embodiment of the invention;

FIG. 3D shows a state machine which implements the AutoLoader controller, according to an embodiment of the invention;

FIG. 4A shows a block diagram of a digital image editing system configured for two users to edit different images stored in the same folder at the same time, according to an embodiment of the invention;

FIG. 4B shows a block diagram of a multi-user computing device, according to an embodiment of the invention;

FIG. 5A shows a flow diagram of a conventional method for inserting images into placeholders;

FIG. 5B shows a flow diagram of the add image operation, according to an embodiment of the invention;

FIG. 5C depicts an image to be inserted into a placeholder, according to an embodiment of the invention;

FIG. 5D depicts an image inserted into a placeholder, according to an embodiment of the invention;

FIG. 5E shows a flow diagram of the routine performed in response to an Add Image keystroke for rectangular images, according to an embodiment of the invention;

FIG. 6A shows an example image before the Auto Vignette operation, and the same image after the Auto Vignette operation, according to an embodiment of the invention;

FIG. 6B shows an image before the Shine Remover operation, and the same image after the Shine Remover operation, according to an embodiment of the invention;

FIG. 6C shows an example overexposed conversion, underexposed conversion, and image after the double exposure operation, according to an embodiment of the invention;

FIG. 6D shows an image before the Thin operation, and the resulting image after the Thin operation, according to an embodiment of the invention;

FIG. 7A shows a digital image editing interface, according to an embodiment of the invention; and

FIG. 7B shows a digital image editing interface, according to an embodiment of the invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts. Although discussed with reference to these illustrations, the present invention is not limited to the illustrations therein. Hence, the reader should regard these illustrations merely as examples of embodiments of the present invention, the full scope of which is measured only in terms of the claims following this description.

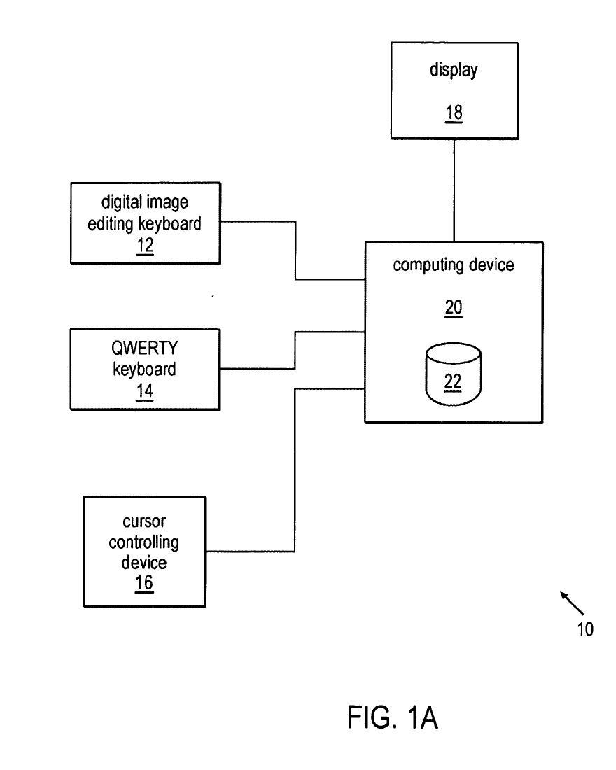

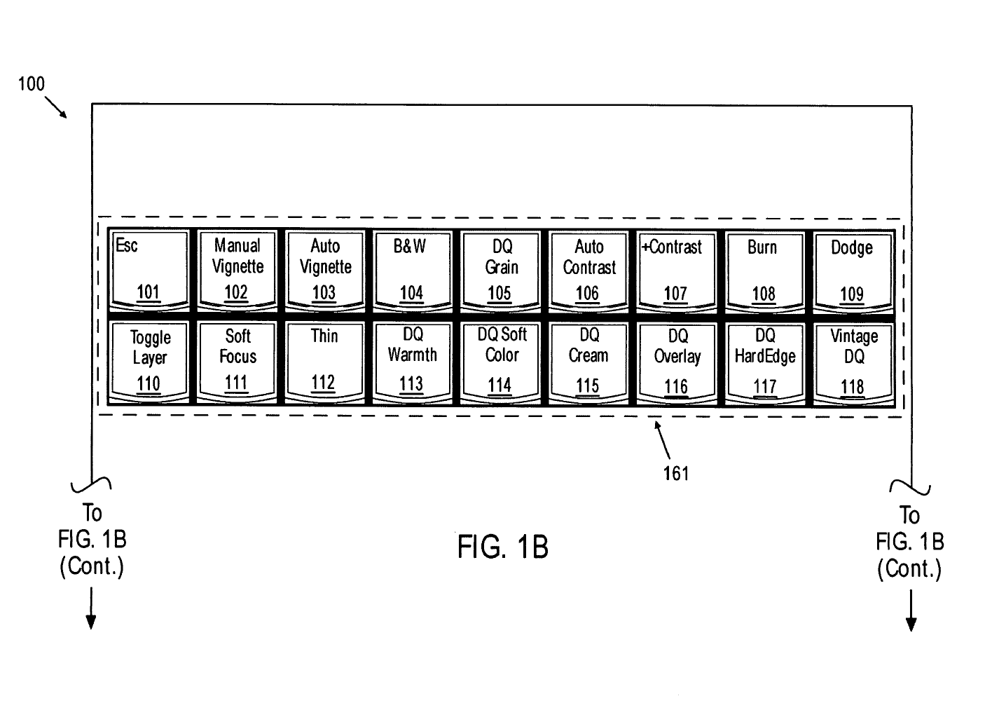

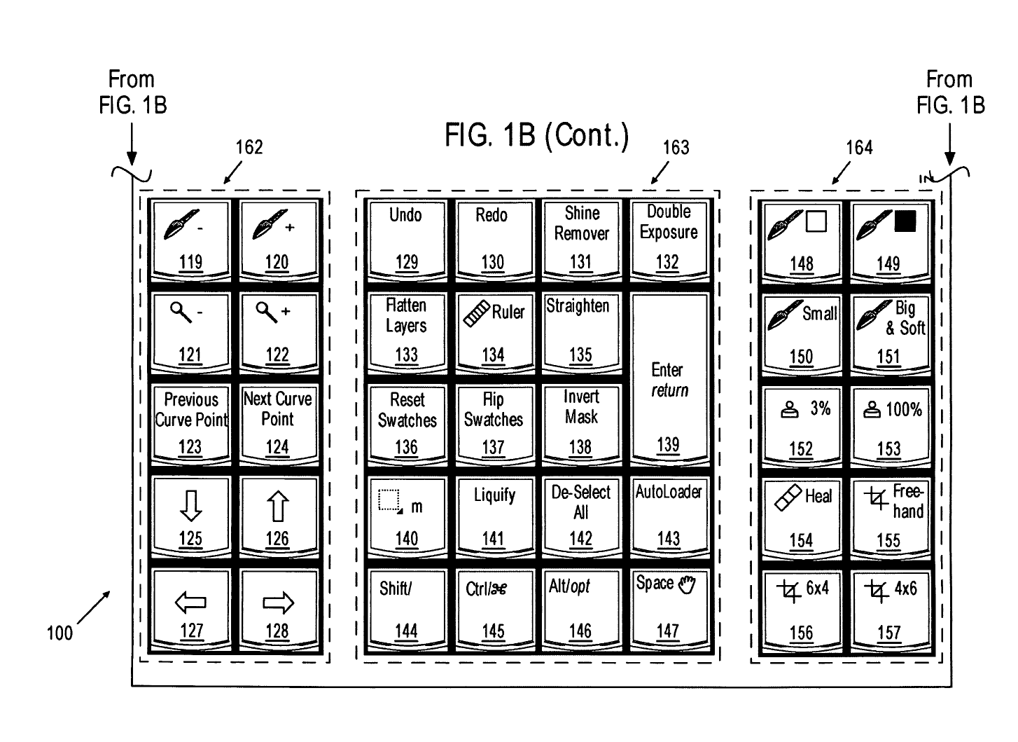

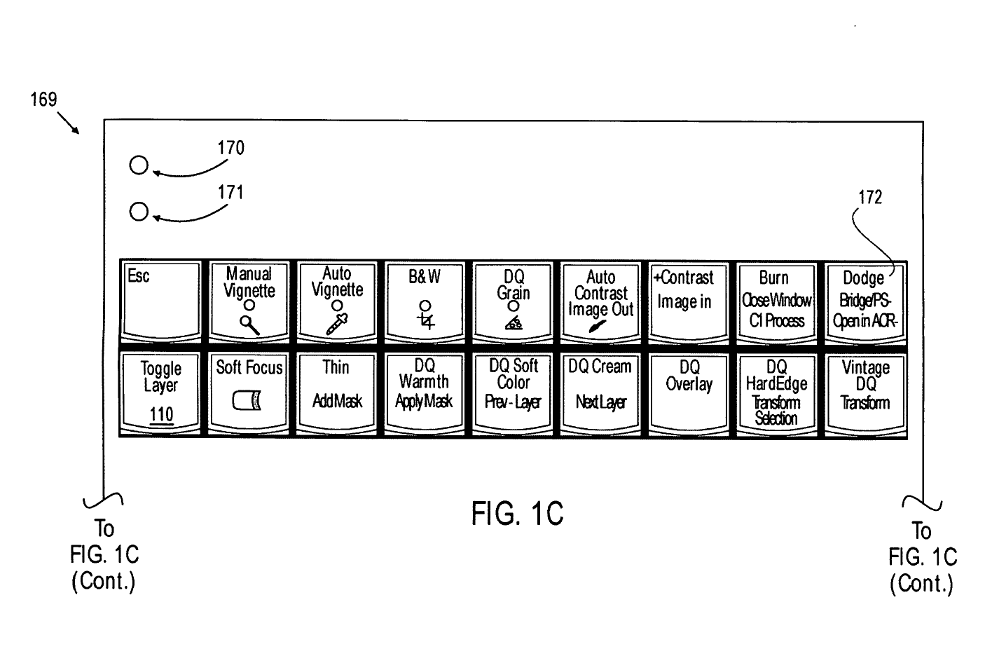

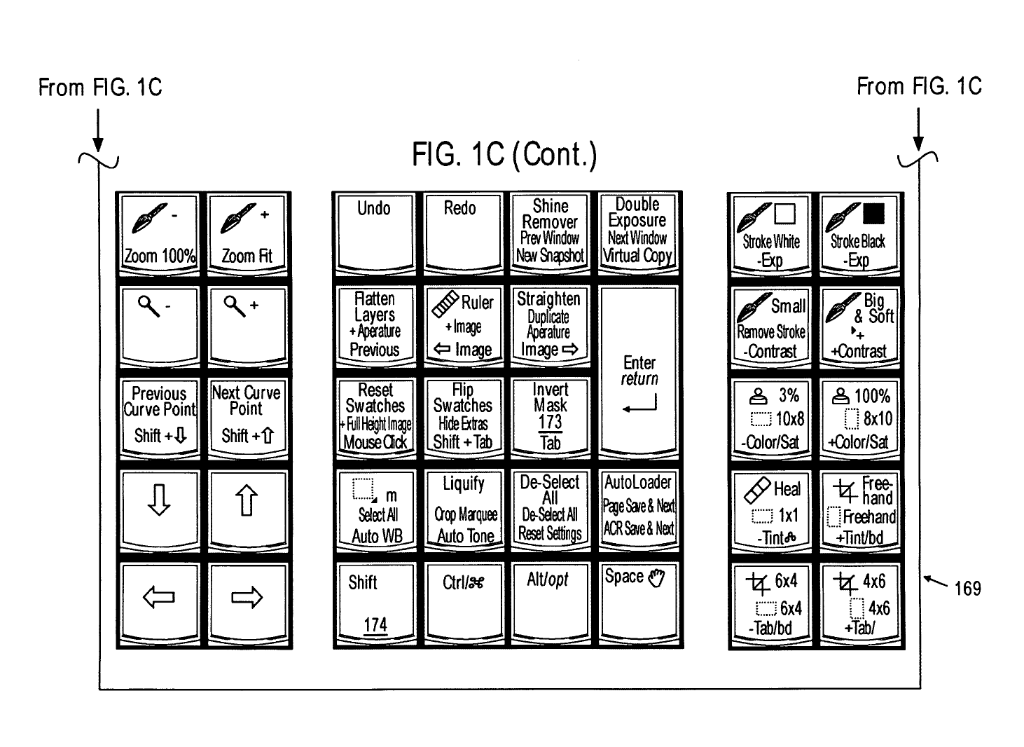

In the present invention, a digital image editing system has been designed to reduce the number of times a user needs to move her hand from one human manipulable interface to another human manipulable interface, thereby minimizing unnecessary hand movement. A human manipulable interface may be an input device, an output device, or both an input and output device. An input device is a device that receives input to the digital image editing system. An output device is a device that transmits output of the digital image editing system. An input device includes, but is not limited to a computer keyboard and cursor controlling device. FIG. 1A depicts a block diagram of a digital image editing system 10, according to an embodiment of the invention. The following human manipulable interfaces, a digital image editing keyboard 12, a QWERTY keyboard 14, and cursor controlling device 16 are interfaced with a computing device 20 through a USB (Universal Serial Bus) interface. However, a PS/2 (Personal System/2), wireless, or other type of interface may be used. The computing device 20 includes, but is not limited to a desktop computer, laptop, workstation, tablet computer, server, handheld device, and mainframe. The cursor controlling device 16 is preferably a pen and tablet which senses pressure as well as position. A pen and tablet allows a user to paint with different levels of intensity depending on the pressure a user places on the tip of the pen, very much like a real paint brush.

The digital image editing keyboard 12 is adapted for the use of a user's non-dominant hand, allowing the user's dominant hand to manipulate the cursor controlling device 16 without switching back and forth between the digital image editing keyboard 12 and cursor controlling device 16. The user positions one or both hands on the QWERTY keyboard 14 infrequently, only when she needs to enter alpha-numeric symbols. The user may position both hands on the digital image editing keyboard 12 if she desires, but this is not necessary as the keyboard is adapted for the use of the non-dominant hand.

The system has an output device, a display 18, interfaced with the computing device 20. Alternatively, the display 18 may be both an input device and an output device simultaneously. In one embodiment, in addition to being an output device, the display 18 is a cursor controlling device, where a finger, stencil, or other apparatus interacting with the display results in cursor events. In one embodiment, the display is a touch-screen monitor.

An interface between components may be a direct or indirect interface, where the components include input devices, output devices, and the computing device. A direct interface means two components are interfaced with one another without the interface involving other components. An indirect interface means two components are interfaced with one another through another component. For example, the QWERTY keyboard 14 is directly interfaced with the computing device 20. In another embodiment, the cursor controlling device maybe indirectly interfaced with the computing device through a USB port on the QWERTY keyboard.

The computing device 20 is configured with a digital image editing application. The computing device 20 contains a repository 22 which stores a mapping of keys to digital image editing operations. The computing device 20 may contain other repositories (not illustrated) to store images, scripts, settings, digital image editing applications, and other information necessary for editing digital images.

The digital image editing keyboard 12 is constructed from a custom keyboard. A custom keyboard includes, but is not limited to the X-keys Professional™ (58 keys) keyboard (hereafter “X-keys Pro”) manufactured by P.I. Engineering, Inc™, and the Cherry™ keypad (model ML4700USB article No. G84-4700PUCUS-2). Key labels are placed on top of each key and encased by transparent key covers. A key label spanning a group of keys may be placed on top of the group and encased by a key cover spanning the group, such as key 139 of the present invention (see FIG. 1B). In the conventional operation, each key of the custom keyboard is mapped to a sequence of keystrokes on the QWERTY keyboard. In the present invention, software is developed to map each key of the custom keyboard to digital image editing operations.

FIG. 1B depicts the digital image editing keyboard 100, according to an embodiment of the invention. Keys are labeled with visual aids that describe the digital image editing operations mapped to the keys. In the present invention, the digital image editing keyboard can have one or more layers of key mappings. The embodiment illustrated in FIG. 1B is implemented with one layer. The labeled keys in FIG. 1B depict the first layer of key mappings. The embodiment illustrated in FIG. 1C is implemented with three layers, but it is possible to configure a different keyboard to have a greater or fewer number of layers. In keyboard 169, the top, middle, bottom row of labels on each key indicate the editing operation of the first, third, and second layers respectively for each key. Take for example key 172, which is mapped to the Dodge operation in the first layer, Bridge/PS operation in the third layer, and Open in ACR operation in the second layer. If a row label is omitted, the operation in the layer corresponding to omitted row is identical to the operation in the first layer. Take for example key 173, which is mapped to the Invert Mask operation in both the first and third layers and the Tab operation in the second layer. As another example, key 174 is mapped to the Shift operation in all layers.

The Toggle Layer key 110 allows a user to select a layer to be the active layer. Indicators indicate the active layer. In one embodiment, the indicators may be located on the digital image editing keyboard, while in another embodiment, the indicators may be located on other input devices or the output device. In one embodiment, the indicators may be a set of LEDs (light emitting diodes) 170, 171, on the digital image editing keyboard (see FIG. 1C), while in another embodiment, the indicators may be text strings on the display. In one embodiment, an ON first LED 170 and OFF second LED 171 indicates that layer 1 is active; an OFF first LED 170 and ON second LED 171 indicates that layer 2 is active; and an ON first LED 170 and ON second LED 171 indicates that layer 3 is active. The first LED may be one color, and the second LED may be a different color. Specifically, the first LED may be green and the second LED may be red. Alternatively, both LEDs may be the same color, and the first LED can be distinguished from the second LED by the position of the LEDs. To clarify, the digital image editing keyboard is both an input and an output device, as indicators display the active layer, an output of the digital image editing system.

In the present invention, keys of the digital image editing keyboard are mapped to editing operations that create new layers in addition to the specified editing operations. A new layer groups all the changes from an editing operation together. This gives the user the choice to subsequently remove, reapply, and refine a group of changes after performing other editing operations. For example, the +Contrast 107, Burn 108, Dodge 109, Heal 154, Manual Vignette 102, Auto Vignette 103, B&W 104, DQ Grain 105, +Contrast 107, Burn 108, Dodge 109, Soft Focus 111, DQ Warmth 113, DQ Soft Color 114, DQ Cream 115, DQ Overlay 116, DQ HardEdge 117, Vintage DQ 118, Shine Remover 131, Double Exposure 132, Clone 3% 152, Clone 100% 153, Heal 154 keys are mapped to editing operations that create one or more new layers in addition to the specified operations.

In one embodiment, the digital image editing keyboard is arranged in groups of keys. In one embodiment, there are four groups: A 161, B 162, C 163, and D 164 (see FIG. 1B). Group A, B, C, and D contain 18, 10, 19, and 10 keys respectively. In the embodiment illustrated in FIG. 1B, the keys have been arranged for the left hand. The user generally positions her left thumb over the Alt 146 and Space keys, and her third and fourth fingers over group B 162. Alternatively, the user may position her second and third fingers over group B 162. To press keys in groups A 161, C 163, and D 164, the user generally must reposition her hand appropriately. In an alternate embodiment where the keys have been arranged for the right hand, the positions of groups B 162 and D 164 have been interchanged. In addition, the position of the Space 147 (Alt 146) key has been interchanged with the Shift 144 (Ctrl 145) key respectively.

In the layout of the keys, keys mapped to digital image editing operations related to one another are arranged adjacent to one another, according to one embodiment of the present invention. This arrangement allows a user to mentally associate spatial areas of the keyboard with editing operations, easily reach keys mapped to related editing operations without repositioning her hand, and facilitates a user to press keys mapped to related editing operation using multiple fingers.

In one embodiment, the brush smaller 119 and brush bigger 120 keys, which both adjust the size of the brush, are located adjacent to one another.

In one embodiment, the zoom-out 121 and zoom-in 122 keys, which both adjust the magnification level, are located adjacent to one another.

In one embodiment, the down 125 and up 126 arrow keys, which adjust the vertical position of an object on the display, are located adjacent to one another. An object on the display includes, but is not limited to the cursor, an image, and a point.

In one embodiment, the left 127 and right 128 arrow keys, which adjust the horizontal position of an object on the display, are located adjacent to one another.

In group B 162, it is further noted that keys for opposite editing operations are arranged adjacent to each other. In the left column of this group, keys are mapped to the brush smaller 119, zoom-out 121, Previous Curve Point 123, down arrow 125, and left arrow operations 127. In the right column of this group the keys, brush bigger 120, zoom-in 122, Next Curve Point 124, up arrow 126, and right arrow 128 are mapped to the opposite commands. In the event that a user overshoots a desired brush size, zoom level, etc., the user can backtrack with the adjacent key without reaching far away, or having to look at the keyboard to find a key.

The marquee 140, Liquify 141, and De Select All 142 keys are used together as a group in the following operations: removing double chins, thinning arms, cheeks and necks, and correcting wide-angle lens distortion. According, they are arranged adjacent to one another, according to the present invention. Because the Liquify operation is very time consuming for the computing device, selecting the portion of the image which needs to be Liquified before applying the Liquify operation takes less time compared with applying the Liquify operation on the entire image. For example, to remove double chins, a user first presses the marquee key 140, enabling the cursor controlling device 16 to select an area of the image containing a double chin. The user then presses the Liquify key 141, which opens the Liquify Filter Dialog Box. The user then chooses an appropriate brush size and uses the cursor controlling device 16 to push and/or pull the double chin to the desired shape. The user then presses the Enter key 139 which applies the Liquify operation and closes the Liquify Filter Dialog Box. Finally, the user presses the De Select All 142 key to unselect the selected area. These three keys located contiguously in the same row allows the user to easily press one key after another when removing double chins, thinning arms, cheeks and necks, and correcting wide-angle lens distortion. While these three keys often are used together as a group, each key may be used in isolation.

The Auto Contrast 106, +Contrast 107, Burn 108, and Dodge 109 keys are related to adjusting contrast, and have been arranged adjacent to one another. The Auto Contrast key 106 first performs the default Photoshop auto contrast operation which adjusts the existing brightness levels to span the full range of possible brightness levels. After the default Photoshop auto contrast operation is performed, an Edit/Fade operation is automatically applied which allows the user to lessen the effect of the auto contrast operation by varying its application from 0% to 100%.

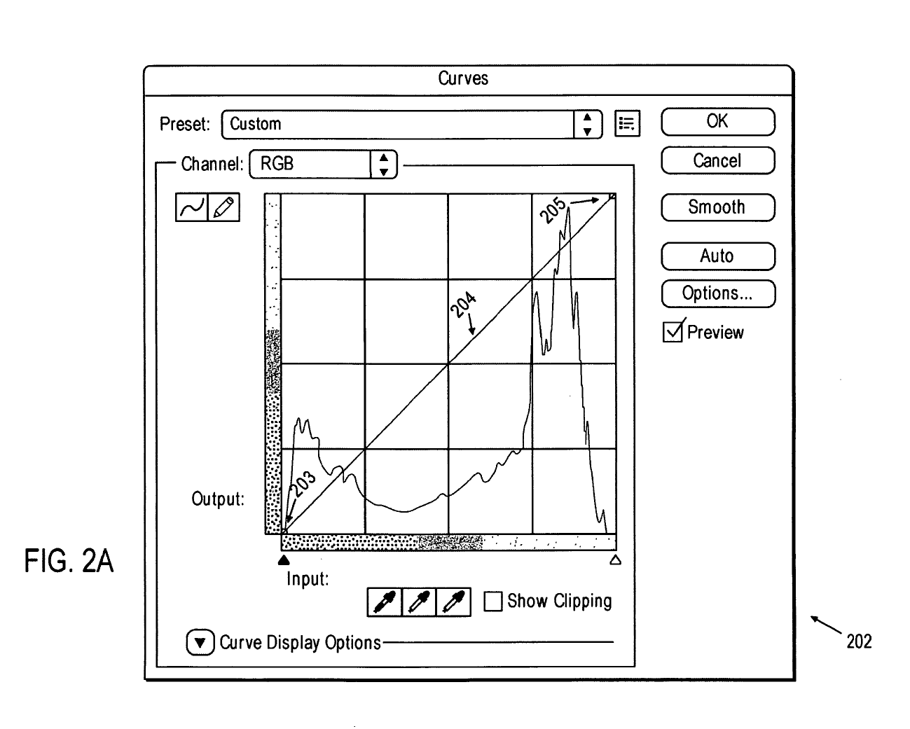

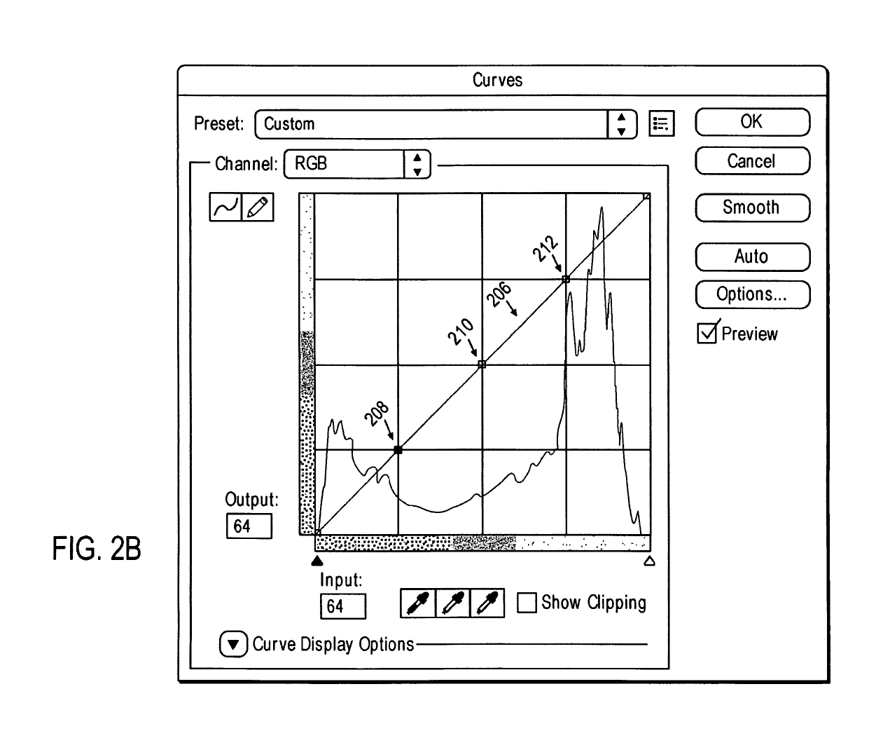

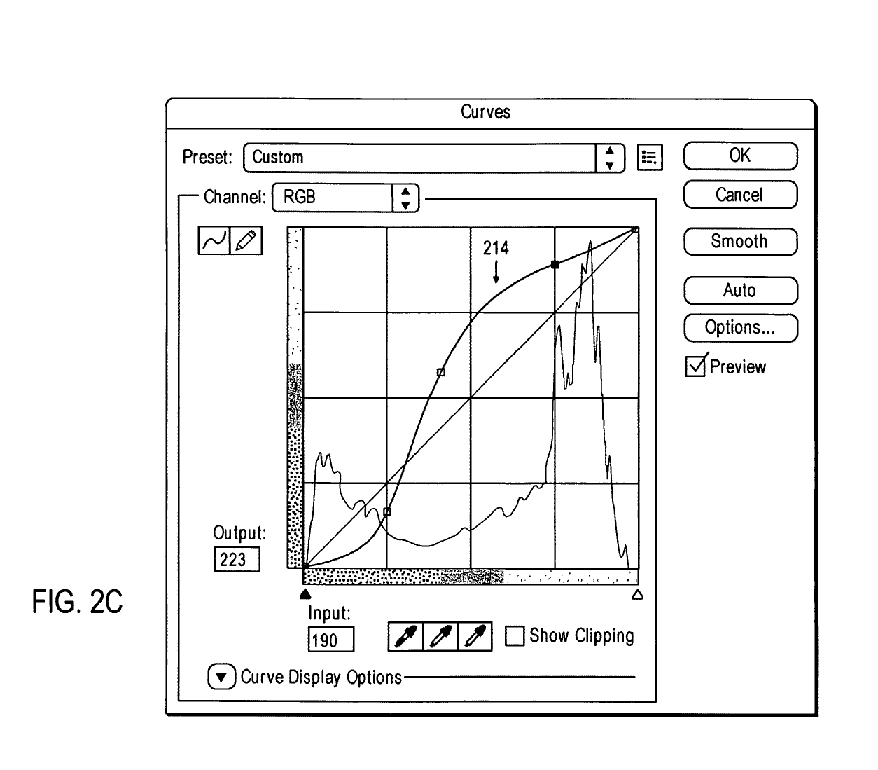

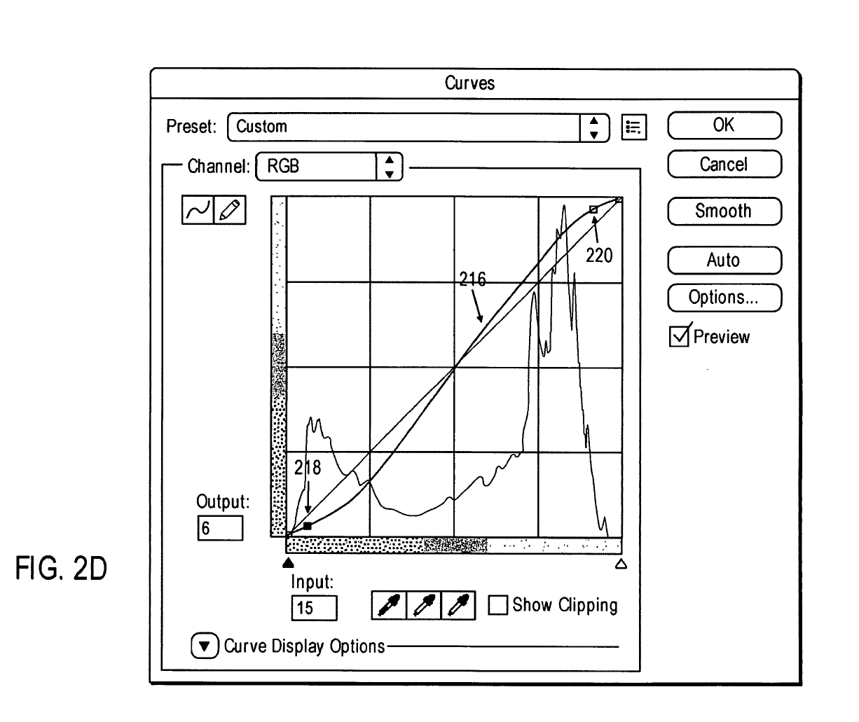

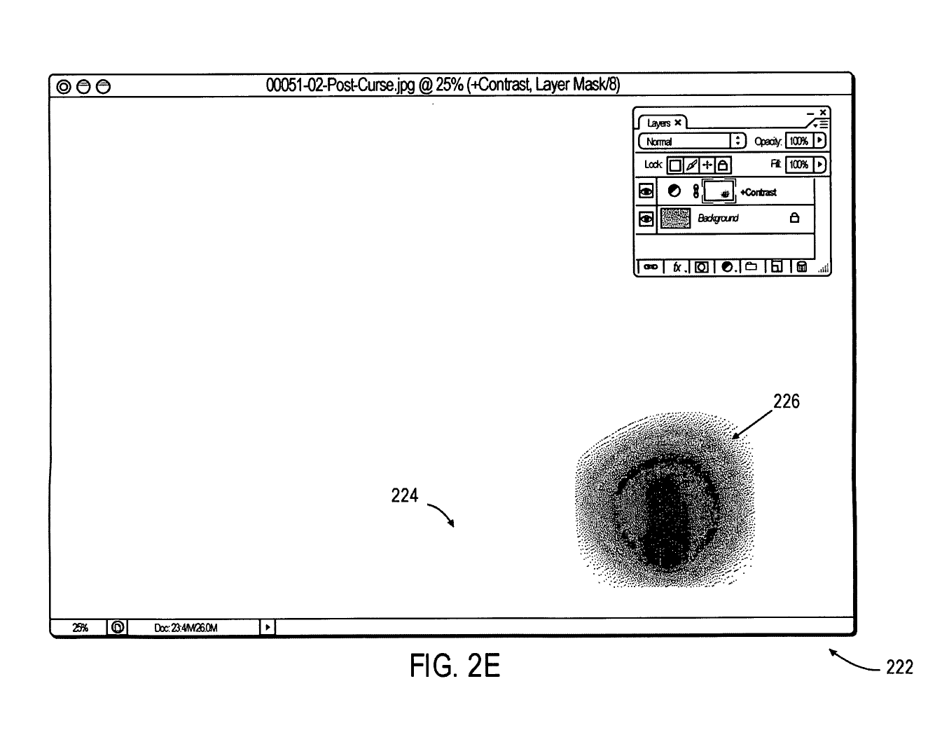

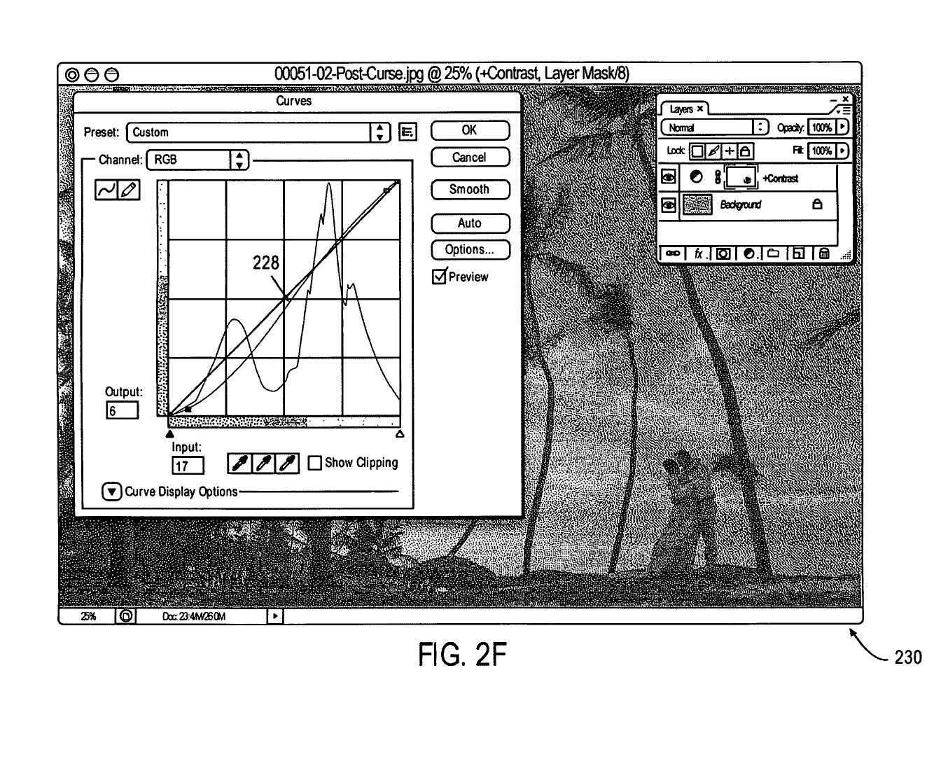

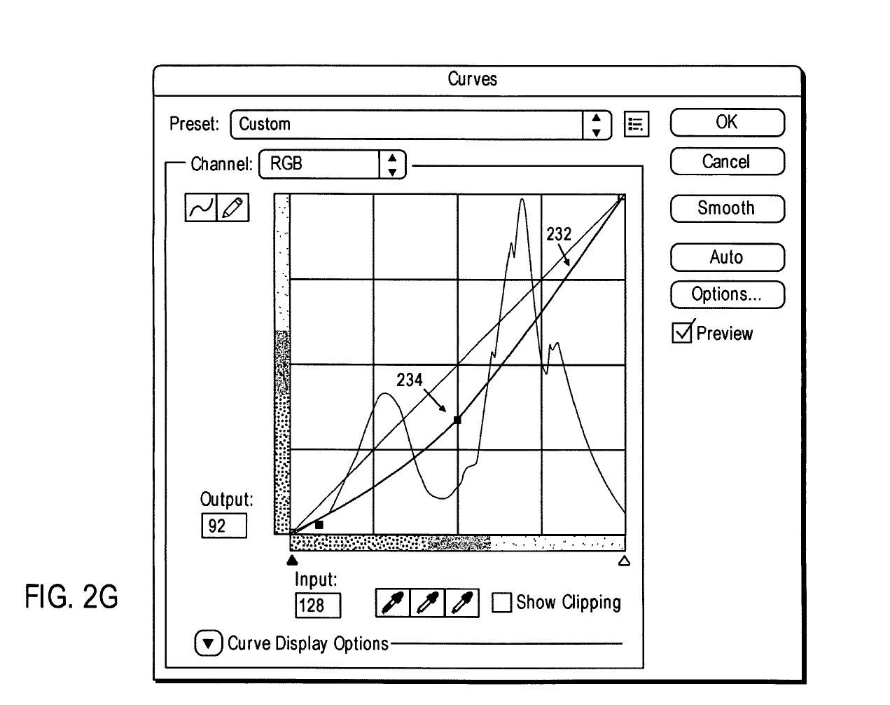

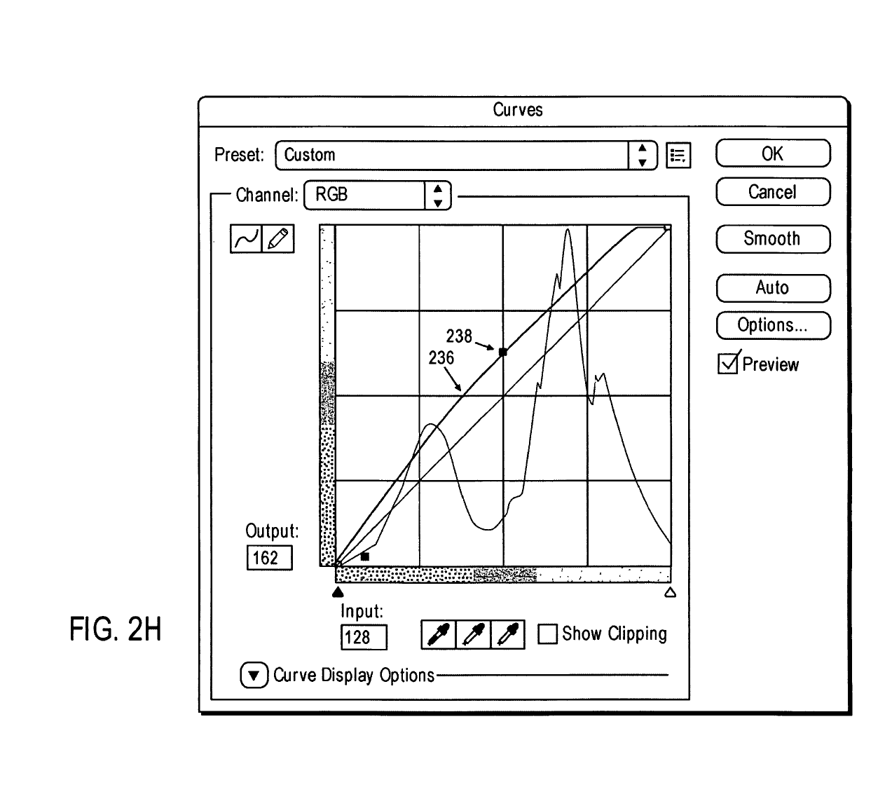

The +Contrast key 107 is mapped to a digital image editing operation encoded by a custom action and script, which helps the user adjust the contrast over a selected area of the image. Pressing the +Contrast key 107 creates a new layer and opens the Photoshop Curves Dialog Box. The Photoshop Curves Dialog Box allows adjustment of the tonality curve, a mapping from original brightness levels to new brightness levels. FIG. 2A depicts the default Photoshop Curves Dialog Box 202 with a linear tonality curve 204, and two default anchor points 203, 205, bolded points on the tonality curve used to adjust the tonality curve. Currently in Photoshop, the user must perform a sequence of cursor events to adjust the tonality curve. First, she must select, using a cursor controlling device, a point on the tonality curve to form an anchor point. The user may form more anchor points by selecting other points on the tonality curve. FIG. 2B depicts a tonality curve 206 with three added anchor points 208, 210, and 212. The user can alter the tonality curve by moving the anchor points in any direction to achieve the desired contrast adjustment. FIG. 2C depicts the resulting tonality curve 214.

In the present invention, the number of user commands needed to adjust the tonality curve is reduced. Importantly, the cursor events have been completely replaced by keystrokes, allowing the user to leave the cursor over the edited image, rather than moving the cursor over the Curves Dialog Box to manipulate the tonality curve. The tonality curve present in the Curves Dialog Box opened in response to the +Contrast key 107 being pressed is not linear, but is already an S curve which increases contrast. From this S curve, the user can fine-tune the tonality curve as she desires, rather than beginning with a linear tonality curve which would require more adjustment. In addition, the S curve comes with one or more added anchor points, whereas in the Photoshop default, the tonality curve comes with two default anchor points, one at either end of the linear curve, which do not provide enough flexibility to form S curves, or other non-linear tonality curves. FIG. 2D depicts an example S curve 216 with two added anchor points 218, 220.

In the present invention, the S curve may be adjusted by a sequence of keystrokes, rather than a sequence of cursor events, allowing the user to maintain the cursor over the image being edited. In the present invention, the first anchor point which changes the tonality of the image is pre-selected, allowing the user to use the arrow keys 125, 126, 127, and 128 to finely move the anchor point, thereby making fine adjustments to the tonality curve. It is noted that the operation of pre-selecting an anchor point is encoded by a script. Holding the Shift key 145, followed by pressing the arrow keys results in coarse adjustments to the tonality curve. The user may press the Previous Curve Point 123 and Next Curve Point 124 keys to select other anchor points on the tonality curve. The Previous Curve Point 123 and Next Curve Point 124 keys, which are both used to select points on the tonality curve, are arranged adjacent to one another, yet another example of the functional arrangement of the keys.

The custom action and script which encodes the +Contrast operation also improves upon the way a user can manipulate a mask, which controls where an editing operation is applied to an image. An example mask 222 which controls the areas of an image where the +Contrast operation defined by S Curve 228 is applied and the resulting image 230 are depicted in FIG. 2E-2F. In the example, the +Contrast operation is applied to all areas of the image, with the exception of the two people. Lighter areas of the mask 224 indicate that more contrast adjustment has been applied to the corresponding areas of the image, while darker areas 226 of the mask indicate corresponding areas of image with less contrast adjustment. In the present invention, the mask associated with the +Contrast operation is white by default, which applies the S curve over the entire image. In addition, the brush tool is pre-selected and set to paint the mask black, which allows the user to remove the application of contrast from areas of the image. If the user prefers to start from a black mask, hiding the effect of the +Contrast operation, she can press the Invert Mask 138 key which will paint the mask black as well as switch the color of the brush to white, allowing her to start painting in the +Contrast effect.

The Burn 108 and Dodge 109 keys are mapped to digital image editing operations encoded by custom actions and scripts, which help the user darken and lighten selected areas of the image respectively. Pressing the Burn key 108 creates a new layer and opens the Photoshop Curves Dialog Box with a Burn tonality curve, which darkens the image. The Burn tonality curve comes with one or more added anchor points. An example Burn tonality curve 232 with one added anchor point 234 is depicted in FIG. 2G. Pressing the Dodge key 109 creates a new layer and opens the Photoshop Curves Dialog Box with a Dodge tonality curve, which lightens the image. The Dodge tonality curve comes with one or more added anchor points. An example Dodge tonality curve 236 with one added anchor point 238 is depicted in FIG. 2H. In the present invention, the masks associated with the Burn and Dodge operations are black so that the Burn and Dodge tonality curves are initially not applied over any part of the image. In addition, the brush tool is pre-selected and set to paint white, which allows the user to selectively darken (lighten) areas of the image according to the Burn (Dodge) curve respectively. If the user wants to start from a white mask, revealing the effect of the Burn or Dodge operation, she can press the Invert Mask 138 key which will paint the mask white as well as switch the color of the brush to black, allowing her to start painting out the Burn or Dodge operation.

The Ruler 134 and Straighten 135 keys are related to correcting tilted images, and have been arranged adjacent to one another. Pressing the Ruler key 134 results in the selection of the Ruler Tool which the user uses to draws a line at the angle she deems to be the correct horizontal or vertical orientation for the image. The user then presses the Straighten key 135 which results in a rotation of the image that makes the line which was previously drawn exactly horizontal or perpendicular, depending on the angle of the line drawn. Finally, the 6×4 Crop Tool is automatically selected for the user to then crop the image as desired.

DQ Soft Color 114, DQ Cream 115, DQ Overlay 116, DQ HardEdge 117, and Vintage DQ 118 are located adjacent to one another, and are each mapped to an editing operation which affects the image not only by tonal values, but also by artistically enhancing the image (see below for more complete description of each key). In the third layer of key mappings, there are also several groups of keys mapped to image editing operations related to one another that are located adjacent to one another. A group includes keys each mapped to the following editing operations (Gradient Tool, which chooses the Gradient Tool from Black to White and is commonly used to paint a gradient in a mask of a placed image to blend the image into the background or other image), (Add Mask, which adds a mask to a layer, allowing the user to reveal and hide portions of the placed image), and (Apply Mask, which rasterizes the Mask of a layer, allowing further masks to be applied to allow creation of complex masks). Another group includes keys each mapped to the following editing operations (Image Out, which takes a placed image and copies it in a new document with matching dimensions) and (Image In, which inserts the edited image back in the same location on the pages from which it came while retaining the original image's layer properties).

In the present invention, keys of the digital image editing keyboard are each mapped to a digital image editing operation encoded by one or more digital image editing application macros or scripts. The AutoLoader key 143 is mapped to an auto loading operation encoded by the AutoLoader script which helps a user to reduce the number of user commands when opening, closing, and saving images. In a conventional operation, a user opens many images, edits the first image, saves and closes the first image, then works on the next image. It is of note that the user has opened many images, which occupy much of the computing device's RAM (Random Access Memory) thereby slowing down the computing device. A more experienced user might go through the routine of opening, editing, saving, and closing an image for each edited image. This routine involves a repeated sequence of user commands, which quickly becomes repetitive when a large number of images are edited.

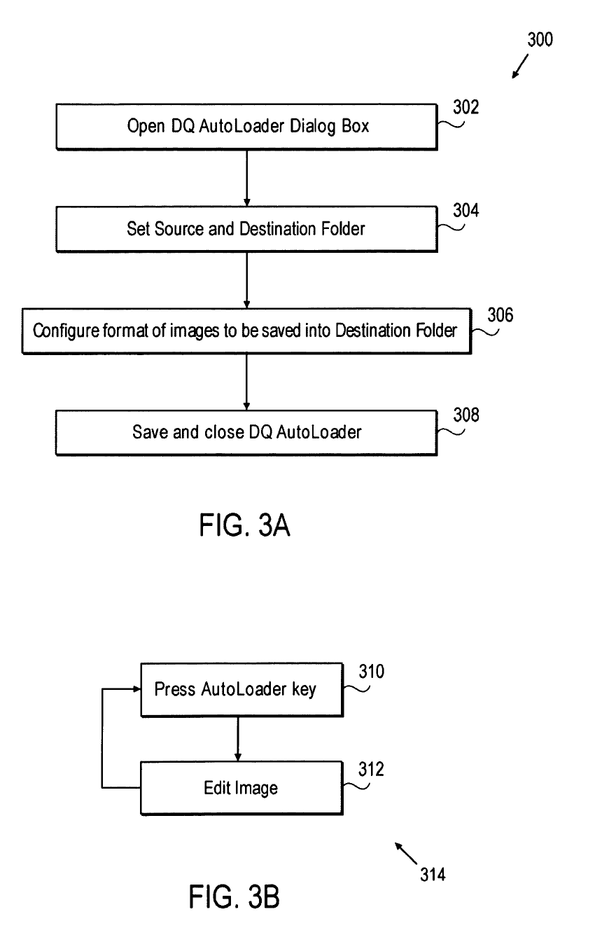

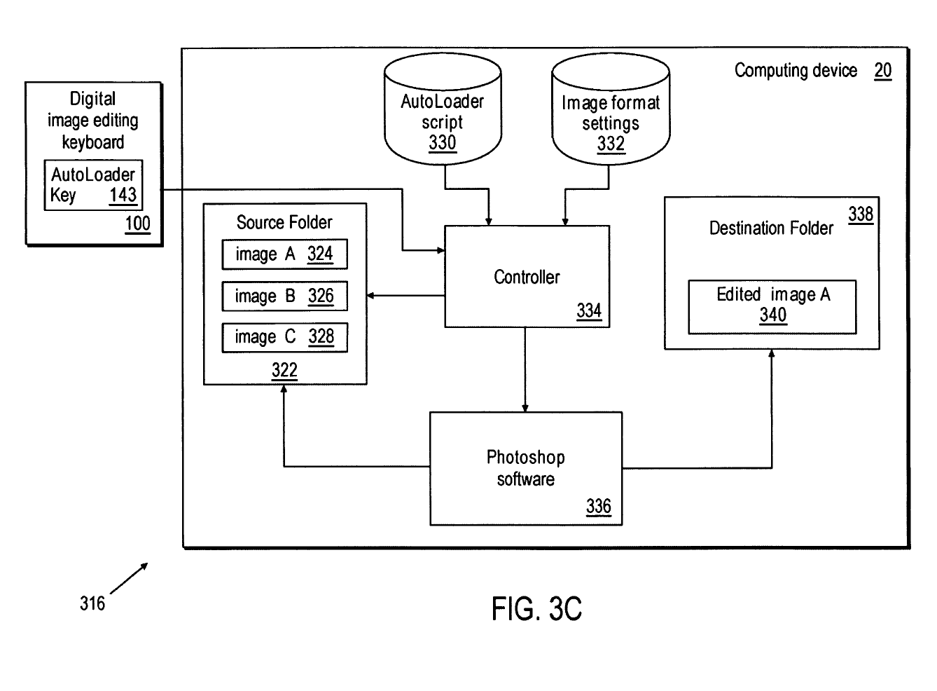

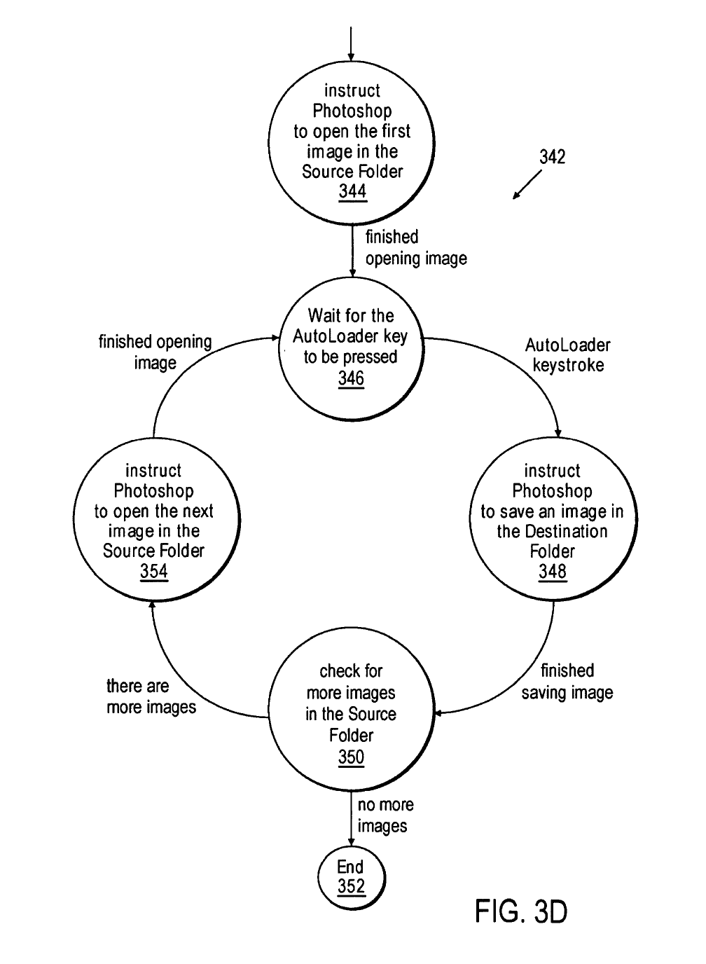

In the present invention, the user first configures the AutoLoader tool. Subsequently a single keystroke of the AutoLoader key replaces the user commands associated with opening, closing, and saving an image. FIG. 3A shows a flow diagram 300 of steps to configure the AutoLoader tool. First, a user opens the DQ AutoLoader Dialog Box 302. The user then sets 304 the Source and Destination Folders, by setting the Source Folder as the folder which stores the images to be edited, and the Destination Folder to be the folder which will store the edited images. The user then configures 306 the format of the images to be saved into the Destination Folder. The user is given the option to save the images as different file types, and select a level of quality compression. A file type includes, but is not limited to PSD (Photoshop Document) and JPEG (Joint Photographic Experts Group). The user then saves and closes 308 the DQ AutoLoader Dialog Box, completing the configuration of the AutoLoader tool. From here on, a single keystroke allows the user to perform the AutoLoader operation.

The flow diagram 314 of FIG. 3B depicts a method of using AutoLoader key 143. The user presses 310 the AutoLoader key which opens the first image in the Source Folder. The user then edits 312 the image. When the user is finished editing the image, pressing the AutoLoader key again 310 saves the image, closes the image, and opens the next image. The user repeats steps 310 and 312 until all images in the Source Folder are edited.

In the embodiment illustrated in FIG. 3C, a system 316 has been configured for the auto loading operation. The AutoLoader key 143 is located on a digital image editing keyboard 100 which is interfaced with a controller 334 in a computing device 20. The controller 334 instructs Photoshop 336 to open images stored in Source Folder 322, and store images to the Destination Folder 338. In the embodiment illustrated in FIG. 3C, Source Folder 322 contains image A 324, image B 326, and image C 328, but Source Folder 322 may contain different number of images in other embodiments. Destination Folder 338 contains edited image A 340, but Destination Folder 338 may contain a different number of edited images in other embodiments. The controller 334 runs the AutoLoader script stored in repository 330, and instructs Photoshop to store files to the Destination Folder 338 according to the image format settings stored in repository 332. The controller 334 may check whether there are more images in the Source Folder 322.

FIG. 3D is a state machine 342 which implements the AutoLoader controller 334, according to an embodiment of the invention. In the initial state 344, the controller instructs Photoshop to open a first image in the Source Folder 322, in response to an AutoLoader keystroke. After Photoshop has opened the first image, the controller 334 waits for an AutoLoader keystroke in state 346. In response to an AutoLoader keystroke, the controller 334 transitions to state 348 and instructs Photoshop to save the edited image to the Destination Folder 338 according to the file configurations stored in repository 332. After Photoshop has saved the image, the controller 334 transitions to state 350 and checks for more images in the Source Folder 322. If there are more images, the controller 334 transitions to state 354 and instructs Photoshop to open the next image in the Source Folder 322 and subsequently transitions to state 346 to wait for an AutoLoader keystroke. Otherwise if there are no more images, the controller 334 proceeds to the END state 352. The controller 334 instructs Photoshop to open images in the Source Folder 322 in an alphabetical order of the image filenames, although a different order, such as a chronological order in which the images were created, or a random order to open the images in the Source Folder 322 is possible.

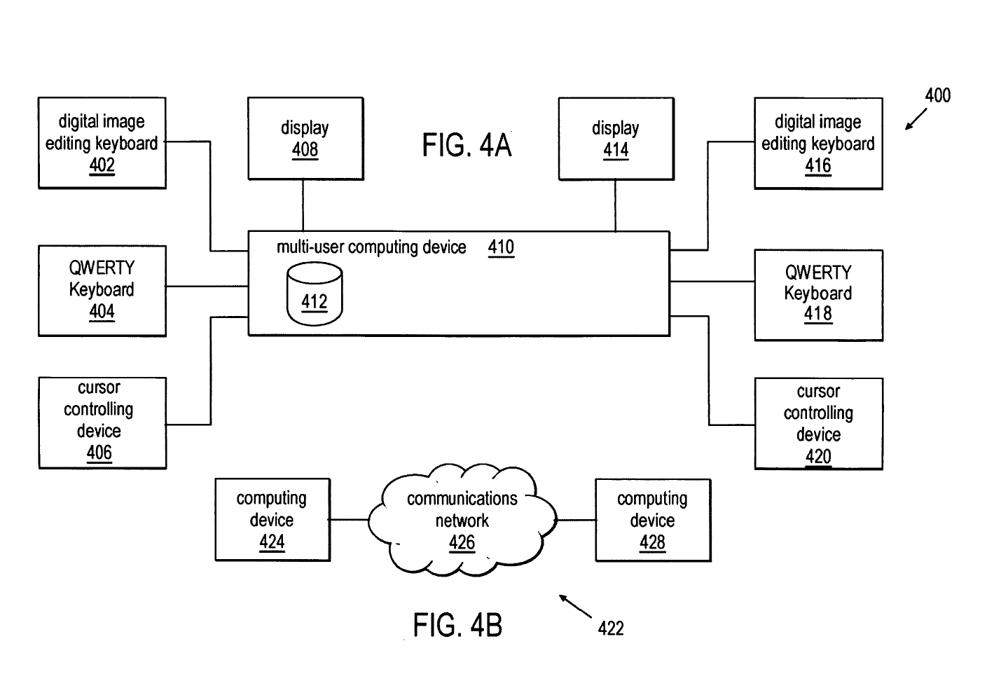

In the present invention, a digital image editing system allows two or more users to edit different images stored in the same folder at the same time. FIG. 4A depicts a digital editing system for two users according to an embodiment of the invention. A multi-user system uses a variation of the AutoLoader routine illustrated in FIGS. 3A-3D. In one embodiment, the images are alphabetically ordered in a list in the Source Folder. A first user edits images from the top of the list and works downwards and the second user edits images from the bottom of the list and works upwards. This routine proceeds until all images are edited. In another embodiment, the images are randomly ordered in a list in the Source Folder and are opened by two or more users. The user who first presses the AutoLoader key opens the first image in the list, and the user who presses the AutoLoader key the next time opens the next image in the list. This routine proceeds until all images are edited. In FIG. 4A, digital image editing keyboards 402 and 416 are interfaced with the multi-user computing device 410. The multi-user computing device, on which two or more users can perform digital image editing simultaneously, includes a single computing device, or two or more computing devices interfaced by a communication network. In one embodiment, a multi-user computing device 422 is implemented by two computing devices 424, 428 interfaced by a communication network 426 as depicted in FIG. 4B. The communication network 426 includes, but is not limited to a Local Area Network, Wireless Network, Wide Area Network, and Metropolitan Area Network. QWERTY keyboards 404 and 418, cursor controlling devices 406 and 420, and displays 408 and 414 are interfaced to the multi-user computing device 410. The displays 408 and 414 may each be an output device. Alternatively, the displays 408 and 414 may each be both an input device and an output device simultaneously. In one embodiment, in addition to being an output device, the displays 408 and 414 may each be a cursor controlling device, where a finger, stencil, or other apparatus interacting with the display results in cursor events. In one embodiment, the displays 408 and 414 may each be a touch-screen monitor. The multi-user computing device 410 is configured to run a digital image editing application, and contains a repository 412 which stores a mapping of keys to digital image editing operations. In the embodiment depicted in FIG. 4A, the human manipulable interfaces 402, 404, 406, and 408 are used by a first user and the human manipulable interfaces 416, 418, 420 and 414 are used by a second user.

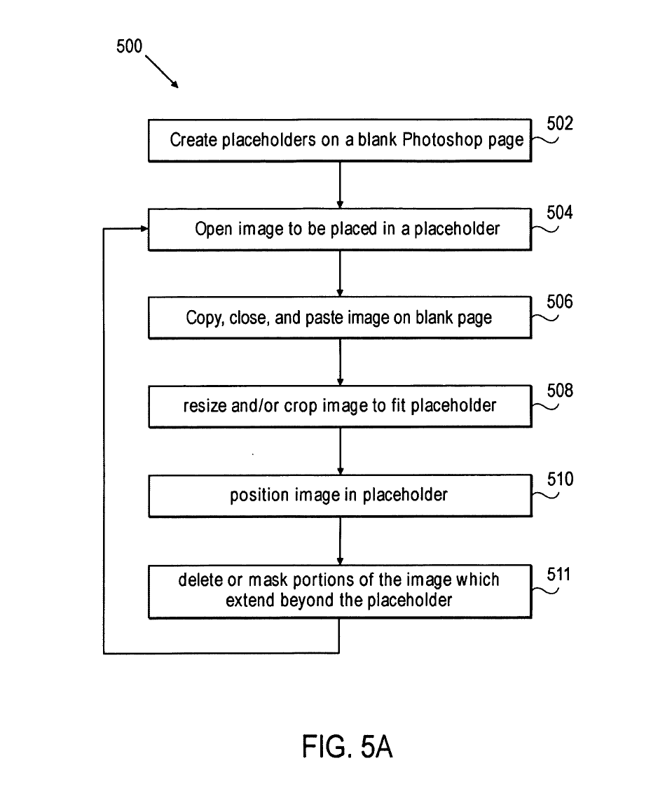

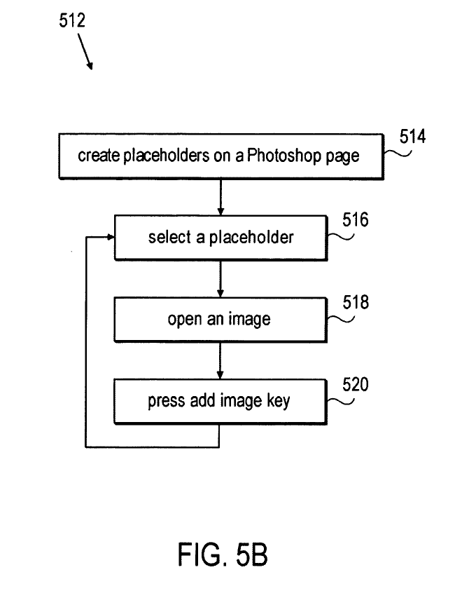

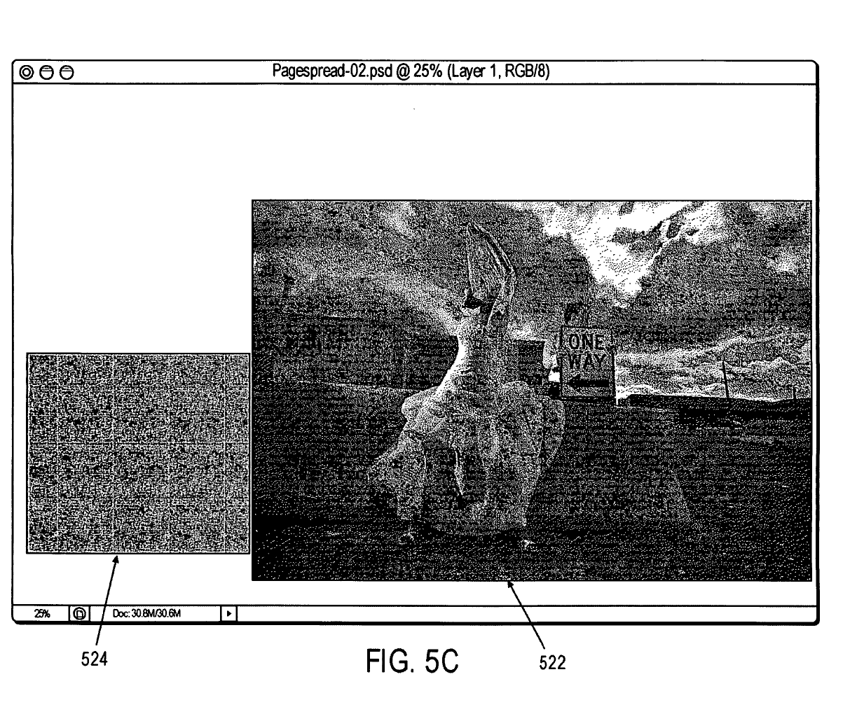

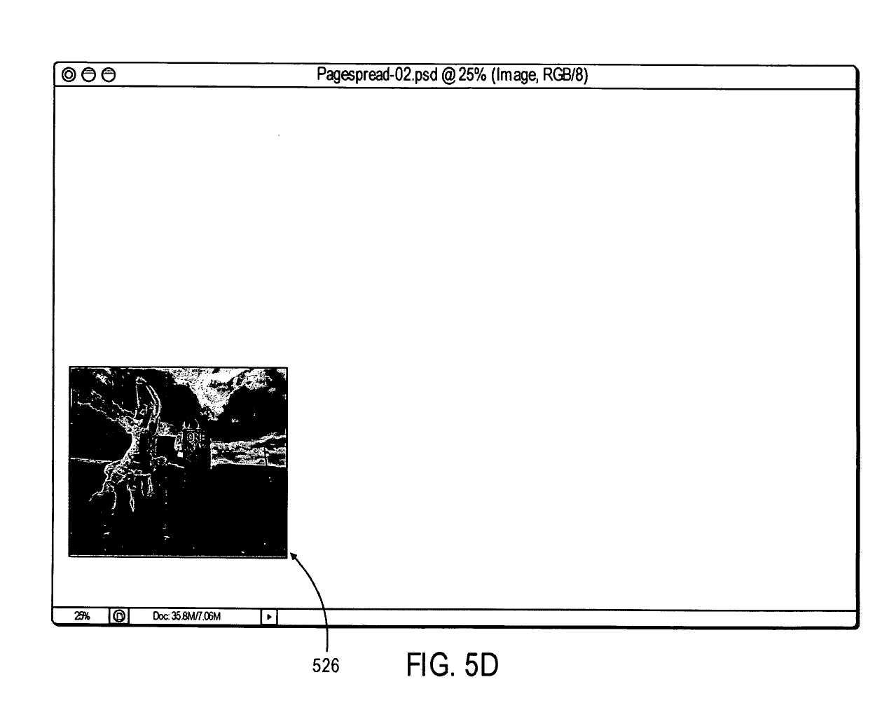

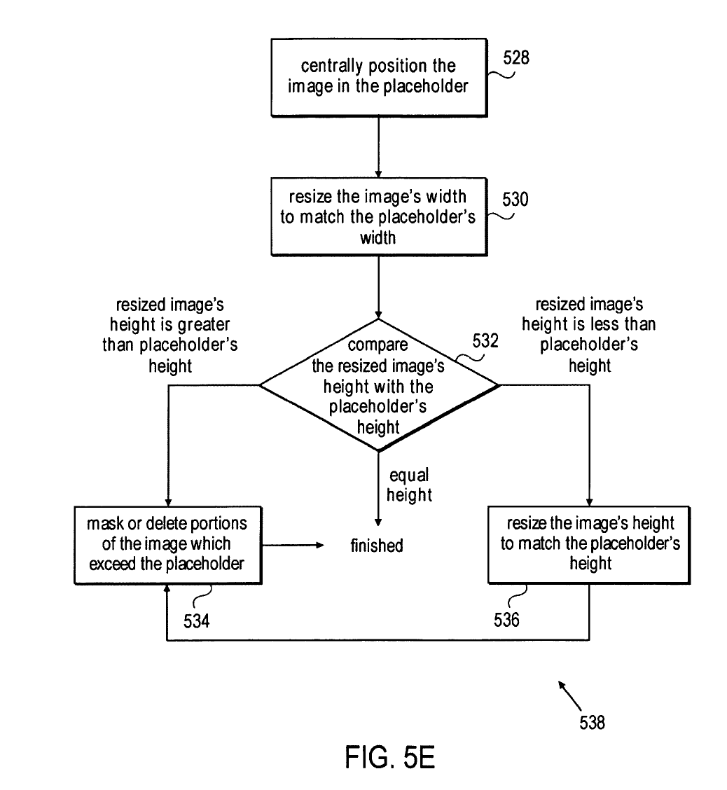

The Add Image key is mapped to the Add Image operation encoded by the Add Image script which allows the user to reduce the number of user commands when inserting images into placeholders, a task a digital image editor often performs when assembling a digital image album. FIG. 5A is a flow diagram 500, which depicts a conventional method of inserting images into placeholders, requiring numerous repeated user commands and intricate resizing and masking techniques. A user first creates placeholders on a blank Photoshop page 502. The user then opens an image to be placed in a placeholder 504. The user copies, closes, and pastes the image onto the blank page 506. Next, the user must resize the image to fit the placeholder 508 by performing an Edit/Free Transform and dragging the bounds of the image. If they wish to keep the original proportions of the image, they must either select the menu button “Maintain Aspect Ratio” using a cursor controlling device every time a Free Transform is executed, or press and hold the <shift> key while dragging the bounds of the image using a cursor controlling device. After resizing, they must position the image in the desired placeholder 510, then press Enter to execute the Free Transform. If the user would like to change the portion of the image shown when placed, they would either have to crop the image 508 after copying and pasting it into the blank page, or delete/mask portions of the image 511 after placing it in the placeholder. The routine beginning from step 504 must be repeated for each subsequent image to be placed in a placeholder.

FIG. 5B depicts a flow diagram 512 illustrating the Add Image operation, according to an embodiment of the invention. The add image algorithm accomplishes the task of placing images into placeholders with much fewer user commands. The user first creates placeholders on a Photoshop page 514. The user then selects a placeholder in which she desires to place an image 516. The user then opens an image 518, and presses the Add Image key 520, which automatically resizes, crops, and positions the image in a placeholder such that the image does not exceed the placeholder's boundaries, all in response to a single keystroke. In one embodiment, the image perfectly fills the placeholder, such that there are no gaps between the image and placeholder's boundaries. In another embodiment, the image lies within the placeholder's boundaries, with gaps between the image and the placeholder's boundaries. The routine from step 516 is repeated for each subsequent image to be placed in a placeholder. FIG. 5C depicts an image 522 to be inserted into placeholder 524. FIG. 5D depicts an image 526 which has been automatically resized, cropped, and positioned to fill the placeholder.

FIG. 5E shows a flow diagram of the routine 538 performed in response to pressing the Add Image key for rectangular images, according to an embodiment of the invention. The image is first centrally positioned in the placeholder 528, by positioning the image's center of mass over the placeholder's center of mass. Next, the image is resized such that its width matches the placeholder's width 530, while maintaining the image's aspect ratio. The resized image's height is compared with the placeholder's height 532. If the heights are equal, the routine is finished. If the resized image's height is greater than the placeholder's height, portions of the resized image which exceed the placeholder's boundaries are masked or deleted 534, completing the routine. If the resized image's height is less than the placeholder's height, the original image is resized such that its height matches the placeholder's height, while maintaining the image's aspect ratio. If the resized image's width is greater than the placeholder's width, portions of the resized image which exceed the placeholder's boundaries are masked or deleted 534, completing the routine.

The Soft Focus key 111 is mapped to a digital image editing operation, encoded by a custom action, which smoothes selected areas of an image. Pressing the Soft Focus key 111 creates a Snapshot of the current state of the image, then duplicates and flattens the image, and executes the Soft Focus Photoshop action on the duplicate file. After the image is softened, this duplicate image is flattened, copied, closed and placed in the original image on a new layer. The mask associated with the action is black by default, and the brush tool is automatically selected and set to paint white, allowing the user to apply the soft focus action to the desired areas of the image. Finally, the history states are Purged to release the computing device's RAM, allowing the computing device to perform at a more optimal rate.

The Heal key 154 is mapped to a digital image editing operation, encoded by a custom action, which creates a new layer placed on top of all other layers, calls the Heal Photoshop action, and configures the Heal brush to have the following settings in one embodiment of the invention: Diameter=55 pixels, Hardness=81%, Spacing=1%, Mode=Normal, Source=Sampled, Aligned and Sampling from All Layers. The Diameter may also be between 20 and 150 pixels; the Hardness may also be between 75% and 90%; and the Spacing may also be between 0% and 5%.

The 3% (100%) Clone key 152 (153) is mapped to a digital image editing operation, encoded by a custom action, which creates a new layer placed on top of all other layers, calls the 3% (100%) Clone Photoshop action respectively, and configures the Clone Tool to have the following settings in one embodiment of the invention: Diameter=90 pixels; Hardness=0%, Mode=Normal, Opacity=100%, Flow=3%, Airbrush capabilities=Enabled, Aligned and Sampling from All Layers. Clone 100% has the same settings as Clone 3% with the exception of Flow=100%. The Diameter may also be between 25 and 150 pixels; the Hardness may also be between 0% and 20%; and the Opacity may also be between 90% and 100%. The Flow may also be between 1% and 10% for the Clone 3% settings, and between 80% and 100% for the Clone 100% settings.

The White brush key 148 is mapped to a digital image editing operation, encoded by a custom action, which sets the foreground and background colors to their default mask values of white and black respectively, and configures the Brush to have the following settings in one embodiment of the invention: Master Diameter=600 pixels, Hardness=0, Mode=Normal, Opacity=100%, Flow=80%, Airbrush capabilities=Enabled. The Master Diameter may also be between 400 and 1200 pixels; the Hardness may also be between 0% and 10%; the Opacity may also be between 80% and 100%; and the Flow may also be between 70% and 100%. The White brush is typically used to paint portions of a mask white, allowing the selective revealing of the layer's contents.

The Black brush key 149 is mapped to a digital image editing operation, encoded by a custom action, which sets the foreground and background colors to black and white respectively, and configures the Brush to have the following settings in one embodiment of the invention: Master Diameter=600 pixels, Hardness=0, Mode=Normal, Opacity=100%, Flow=80%, Airbrush capabilities=Enabled. The Master Diameter may also be between 400 and 1200 pixels; the Hardness may also be between 0% and 10%; the Opacity may also be between 80% and 100%; and the Flow may also be between 70% and 100%. The Black brush is typically used to paint portions of a mask black, allowing the selective hiding of the layer's contents.

The Small brush key 150 is mapped to a digital image editing operation, encoded by a custom action, which chooses the Brush tool having the following settings in one embodiment of the invention: Master Diameter=30 pixels, Hardness=0%, Mode=Normal, Opacity=100%, Flow=80%, Airbrush capabilities=Enabled. The Master Diameter may also be between 20 and 60 pixels; the Hardness may also be between 0% and 10%; the Opacity may also be between 80% and 100%; and the Flow may also be between 70% and 100%. Unlike the White and Black brushes, no colors are chosen for the Small brush. This key is typically pressed when small details need attention. For example, the user may press the Dodge key 109 and create a curve to lighten the eyes in a portrait. The editing operation chooses the White brush which is the right color, but much too large and having much too soft an edge to accurately paint only the eyes. By pressing the Small brush key 150 after executing the Dodge key, the user can accurately lighten the eyes by using this smaller, harder-edged brush.

The Big & Soft brush key 151 is mapped to a digital image editing operation, encoded by a custom action, which chooses the Brush tool having the following settings in one embodiment of the invention: Master Diameter=1100 pixels, Hardness=0%, Mode=Normal, Opacity=100%, Flow=20%, Airbrush capabilities=Enabled. The Master Diameter may also be between 1000 and 1600 pixels; the Hardness may also be between 0% and 2%; the Opacity may also be between 80% and 100%; and the Flow may also be between 10% and 30%. This key is typically pressed when large areas of a mask need to be altered with a soft, feathered edge. The soft edge, low flow rate and large size helps prevent harsh dark/light edge transitions when dealing with masks of layers which change the tonality of the image.

The Free-hand Crop key 155 is mapped to a digital image editing operation, encoded by a custom action, which chooses the Crop Tool having the following settings in one embodiment of the invention: Undefined Width, Height and Resolution. This allows for the unconstrained cropping of images without resampling the image.

The 6×4 Crop key 156 is mapped to a digital image editing operation, encoded by a custom action, which chooses the Crop Tool having the following settings in one embodiment of the invention: Width=6 inch, Height=4 inch, Resolution=undefined. This allows for the cropping of image with a ratio of 3:2 without resampling the image.

The 4×6 Crop key 157 is mapped to a digital image editing operation, encoded by a custom action, which chooses the Crop Tool having the following settings in one embodiment of the invention: Width=4 inch, Height=6 inch, Resolution=undefined. This allows for the cropping of image with a ratio of 2:3 without resampling the image.

The Manual Vignette key 102 is mapped to a digital image editing operation, encoded by a custom action, which creates a new Levels Adjustment Layer which allows the selective darkening of the image. The Levels Adjustment Layer is created with the following settings in one embodiment of the invention: Mode=Luminosity, Input=100, 255, Output=0, 175. Next the mask is painted black, hiding the darkening effect of the Levels Adjustment Layer. Next the Big & Soft brush is selected and configured to paint white allowing the user to paint the darkening effect into the black mask. Finally, the history states are Purged to release the computing device's RAM, allowing the computing device to perform at a more optimal rate.

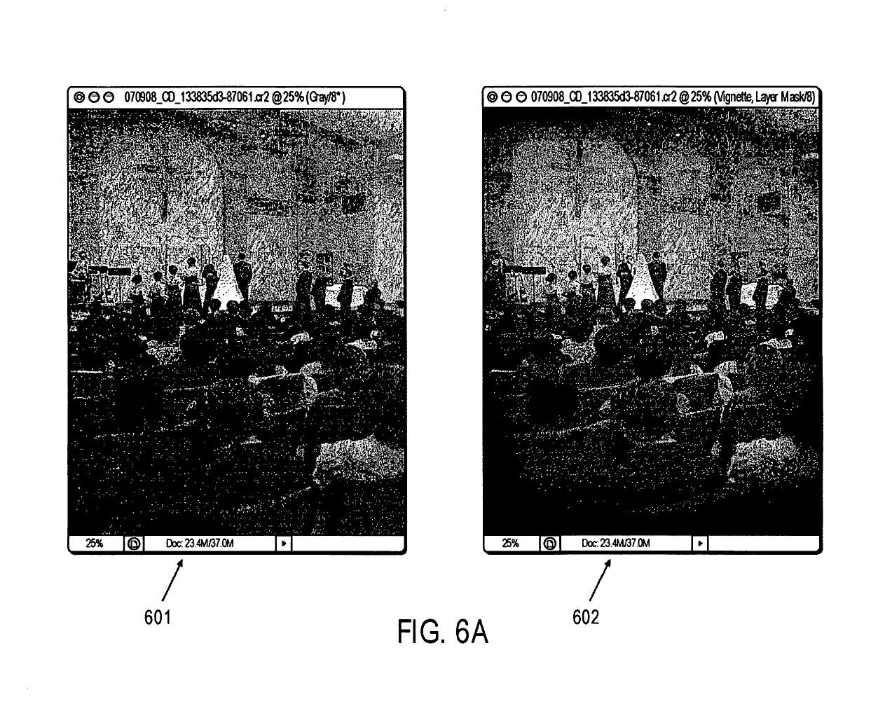

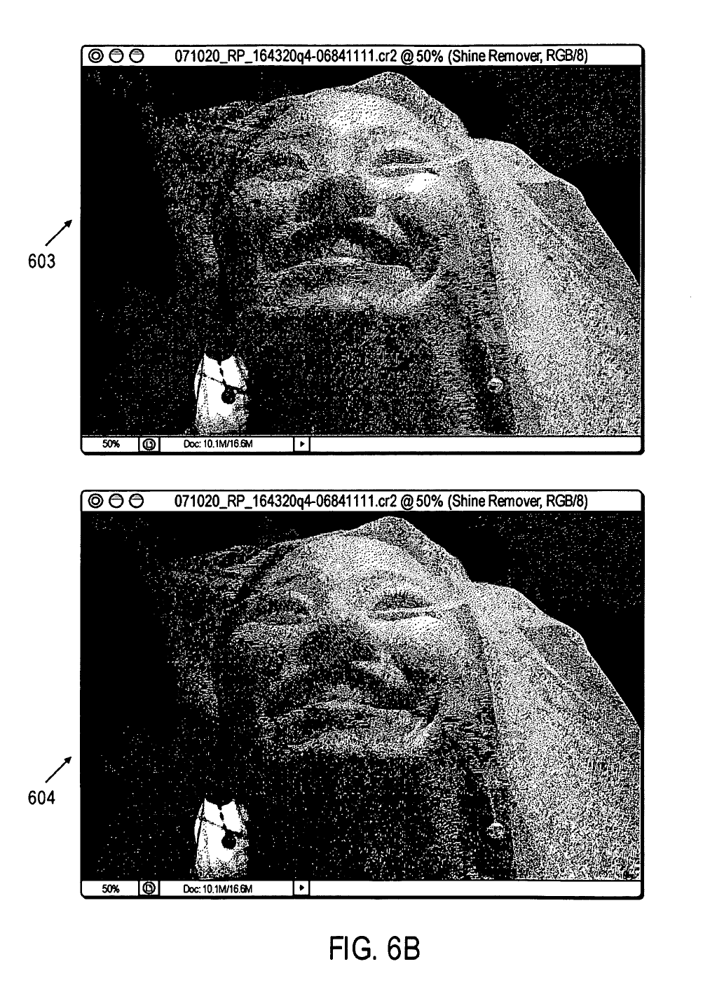

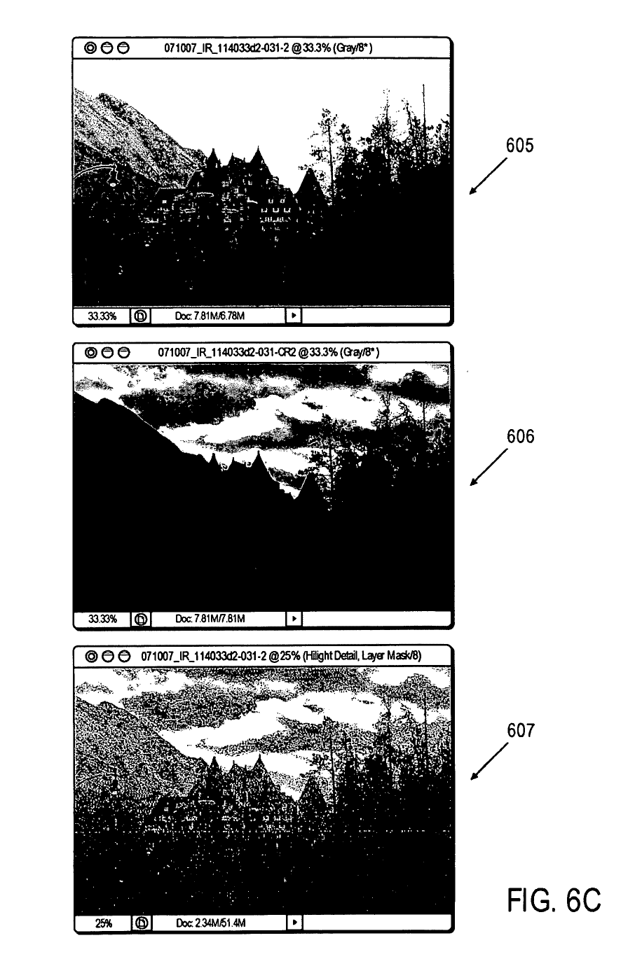

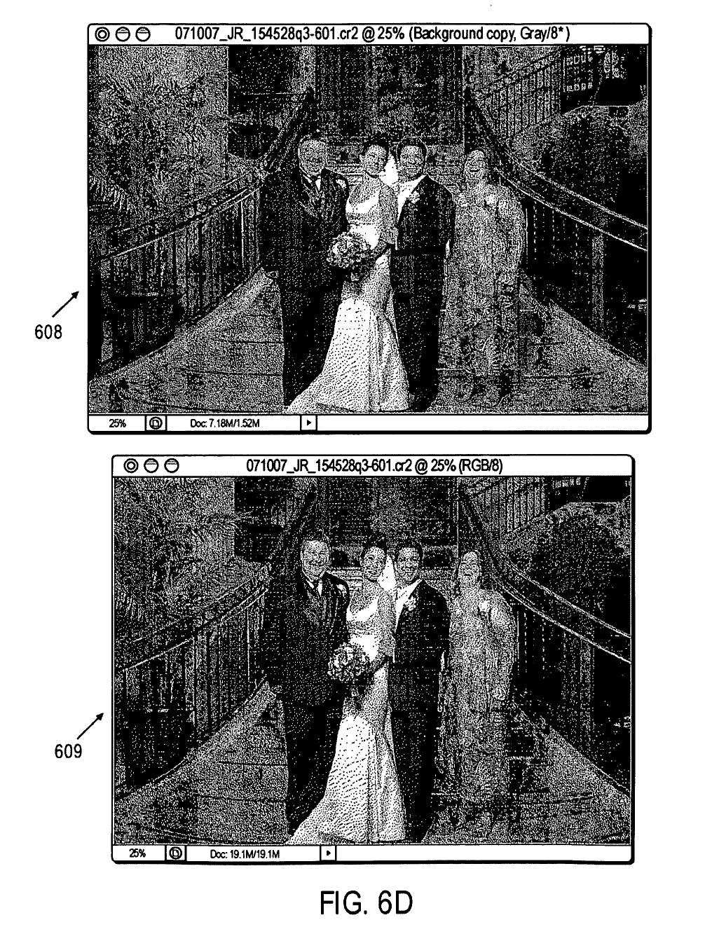

The Auto Vignette key 103 is mapped to a digital image editing operation, encoded by a custom action, which creates a new Levels Adjustment Layer which darkens the outer edges of the image. The Levels Adjustment Layer is created with the following settings in one embodiment of the invention: Opacity=85%, Mode=Luminosity, Input=63, 255, Gamma=0.88, Output=0, 244. The Opacity may also be between 75% and 100% and Gamma may also be between 0.80 and 0.95. The mask is then modified to only show the darkening effect of this Levels Adjustment Layer around the outer edges of the image with a large feathered edge to an unaffected area in the centre of the image. Next the Black Brush Tool is selected and configured to paint black allowing the user to paint away the darkening effect. Finally, the history states are Purged to release the computing device's RAM, allowing the computing device to perform at a more optimal rate. FIG. 6A shows an image before the Auto Vignette operation 601, and the same image after the Auto Vignette operation 602. Notice the darkening around the edges of image 602.

The B&W key 104 is mapped to a digital image editing operation, encoded by a custom action, which converts the image to black and white. Pressing the B&W key 104 creates a Snapshot of the current state of the image, then duplicates and flattens the image, and executes the B&W Photoshop action on the duplicate file. After the image is converted to black & white, the duplicate image is flattened, copied, closed and placed in the original image on a new layer. Finally, the history states are Purged to release the computing device's RAM, allowing the computing device to perform at a more optimal rate.

The DQ Grain key 105 is mapped to a digital image editing operation, encoded by a custom action, which adds film-like grain to an image. After the grain-effected layer is added, the history states are Purged to release the computing device's RAM, allowing the computing device to perform at a more optimal rate.

The DQ Warmth key 113 is mapped to a digital image editing operation, encoded by a custom action, which applies a hue-saturation change and custom curve to add reds and yellows to the image. Pressing the DQ Warmth key 113 creates a Snapshot of the current state of the image, then duplicates and flattens this duplicate image, and executes the DQ Warmth Photoshop action on the duplicate file. After the image is warmed, the duplicate image is flattened, copied, closed and placed in the original image on a new layer. Finally, the history states are Purged to release the computing device's RAM, allowing the computing device to perform at a more optimal rate.

The DQ Soft Color key 114 is mapped to a digital image editing operation, encoded by a custom action, which adjusts the contrast while mildly softening and desaturating the image. Pressing the DQ Soft Color key 114 creates a Snapshot of the current state of the image, then duplicates and flattens the image, and executes the DQ Soft Color Photoshop action on the duplicate file. After the image has the desired effect applied, this duplicate image is flattened, copied, closed and placed in the original image on a new layer. The mask associated with this new layer is white, and the brush tool is automatically selected to black, allowing the user to remove the DQ Soft Color effect from desired areas of the image. Finally, the history states are Purged to release the computing device's RAM, allowing the computing device to perform at a more optimal rate.

The DQ Cream key 115 is mapped to a digital image editing operation, encoded by a custom action, which adjusts the contrast while mildly softening the image. Pressing the DQ Cream key 115 creates a Snapshot of the current state of the image, then duplicates and flattens the image, and executes the DQ Cream Photoshop action on the duplicate file. After the image has the desired effect applied, this duplicate image is flattened, copied, closed and placed in the original image on a new layer. The mask associated with this new layer is painted white, and the brush tool is automatically selected to paint black, allowing the user to remove the DQ Cream effect from desired areas of the image. Finally, the history states are Purged to release the computing device's RAM, allowing the computing device to perform at a more optimal rate.

The DQ Overlay key 116 is mapped to a digital image editing operation, encoded by a custom action, which adjusts the contrast, selectively saturates colors and adds a slight softening effect. Pressing the DQ Overlay key 116 creates a Snapshot of the current state of the image, then duplicates and flattens the image, and executes the DQ Overlay Photoshop action on the duplicate file. After the image has the desired effect applied, this duplicate image is flattened, copied, closed and placed in the original image on a new layer. The mask associated with this new layer is painted white, and the brush tool is automatically selected to paint black, allowing the user to remove the DQ Overlay effect from desired areas of the image. Finally, the history states are Purged to release the computing device's RAM, allowing the computing device to perform at a more optimal rate.

The DQ HardEdge key 117 is mapped to a digital image editing operation, encoded by a custom action, which drastically increases the contrast and adds a strong sepia toning to the image. Pressing the DQ HardEdge key 117 creates a Snapshot of the current state of the image, then duplicates and flattens the image, and executes the DQ HardEdge Photoshop action on the duplicate file. After the image has the desired effect applied, this duplicate image is flattened, copied, closed and placed in the original image on a new layer. The mask associated with this new layer is painted white, and the brush tool is automatically selected to black, allowing the user to remove the DQ Soft Color effect from the desired areas of the image. A second layer, named the DQ HardEdge Toner layer, is added on top of the DQ HardEdge layer to allow independent adjustment of the added contrast and toning. Finally, the history states are Purged to release the computing device's RAM, allowing the computing device to perform at a more optimal rate.

The Vintage DQ key 118 is mapped to a digital image editing operation, encoded by a custom action, which adds a sepia toning to the image. Pressing the Vintage DQ key 118 creates a Snapshot of the current state of the image, then duplicates and flattens the image, and executes the Vintage DQ Photoshop action on the duplicate file. After the image has the desired effect applied, this duplicate image is flattened, copied, closed and placed in the original image on a new layer. To vary the amount of the applied effect, the user can decrease or increase the opacity of the newly added layer from its default value of 45%. Finally, the history states are Purged to release the computing device's RAM, allowing the computing device to perform at a more optimal rate.

The Shine Remover key 131 is mapped to a digital image editing operation, encoded by a custom action, which creates a new layer, calls the Shine Remover Photoshop action, and configures the Brush Tool to have the following settings in one embodiment of the invention: Master Diameter 30 pixels, Hardness=0%, Mode=Color Burn, Opacity=100%, Flow 20%, and Airbrush Capabilities=Enabled. The Master Diameter may also be between 20 and 60 pixels; the Hardness may also be between 0% and 2%; the Opacity may also be between 80% and 100%; and the Flow may also be between 10% and 40%. The user can then remove shiny or oily patches of skin by sampling a section of non-oily skin (by pressing and holding the Alt/Opt key 146 and clicking the non-oily section) and painting over the shiny sections. FIG. 6B shows an image before the Shine Remover operation 603, and the same image after the Shine Remover operation 604. Notice the reduction of shine on the forehead, cheeks, nose, lower lip, and chin in image 604.

The Double Exposure key 132 is mapped to a digital image editing operation, encoded by a custom action, which combines the light and dark tonalities of an underexposed and overexposed conversion of the same RAW file respectively, thereby extending the dynamic range of the image when compared to a single conversion of the RAW file. Before the action is run, the original RAW file must be converted twice: first an underexposed conversion which retains more highlight detail while forgoing shadow detail, and second the overexposed conversion which retains more shadow detail while forgoing highlight detail. The user opens both converted JPEG's in Photoshop, and places the focus on the underexposed conversion. Pressing the Double Exposure key 132 copies, closes and pastes the underexposed conversion in the overexposed conversion's document on its own layer. A mask is then automatically created which reveals the lighter tonalities of the underexposed image. Next, the Big & Soft brush is automatically selected to white, allowing the user to reveal more of the underexposed layer. Finally, the history states are Purged to release the computing device's RAM, allowing the computing device to perform at a more optimal rate. FIG. 6C shows an example overexposed conversion 605, underexposed conversion 606, and image after the double exposure operation 607. Notice the improved dynamic range of the resulting image 607.

The Flatten Layers key 133 is mapped to a digital image editing operation, encoded by a custom action, which executes a Flatten Layers command.

The Thin key 112 is mapped to a digital image editing operation, encoded by a custom action, which transforms the image horizontally. Pressing the Thin key 112 creates a Snapshot of the current state of the image, flattens the image, and duplicates the resulting flattened layer. A Free Transform is executed on the top duplicate layer with the height unchanged and width set to 98%. The width may also be set between 90% and 99%. The Free Transform state waits for the user to input any further changes to the Width adjustment. When satisfied with the thinning amount, the user presses the Enter key 139 and the 6×4 Crop Tool is automatically selected for the user to then crop the image to remove the un-transformed section of the lower layer. Finally, the history states are Purged to release the computing device's RAM, allowing the computing device to perform at a more optimal rate. FIG. 6D shows an image before the Thin operation 608, and the resulting image after the Thin operation 609.

The digital image editing keyboard 100 includes the following modifier keys which are mapped to the corresponding keys of the QWERTY keyboard: Esc 101, down arrow 125, up arrow 126, left arrow 127, right arrow 128, Shift 144, Ctrl (Apple Command) 145, Alt (Apple Option) 146, Space 147, and Enter (Apple Return) 139. The digital image editing keyboard 100 also includes the following keys mapped to digital image editing operations encoded by Photoshop macros: Undo 129, Redo 130, Ruler 134, Reset Swatches 136, Flip Swatches 137, Invert Mask 138, De-Select All 142, brush smaller 119, brush bigger 120, zoom-out 121, zoom-in 122, Previous Curve Point 123, and Next Curve Point 124.

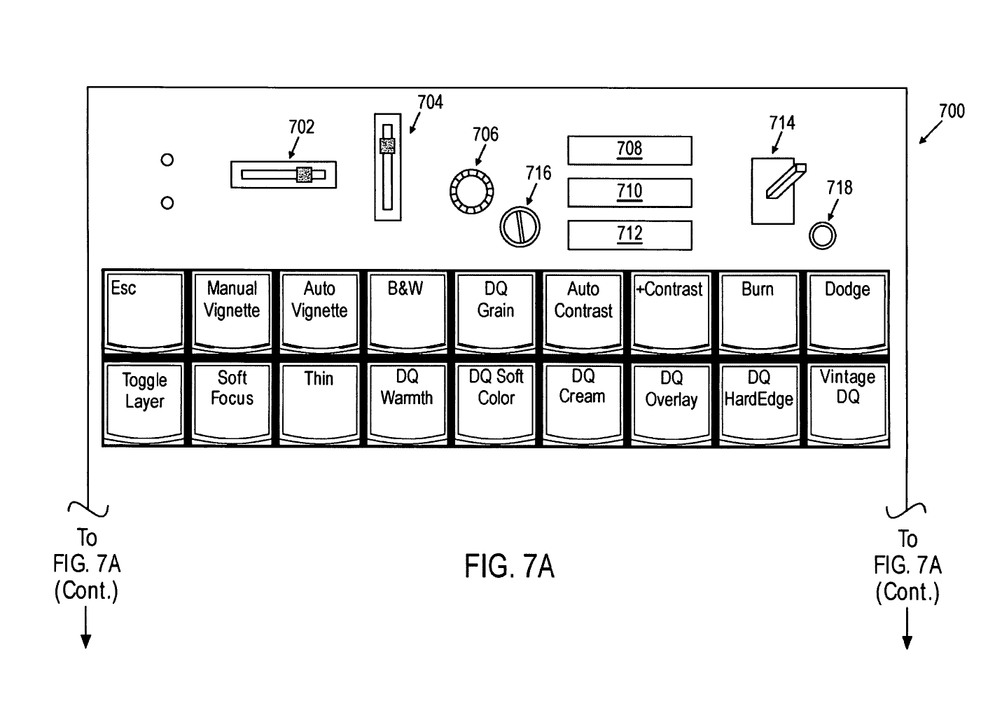

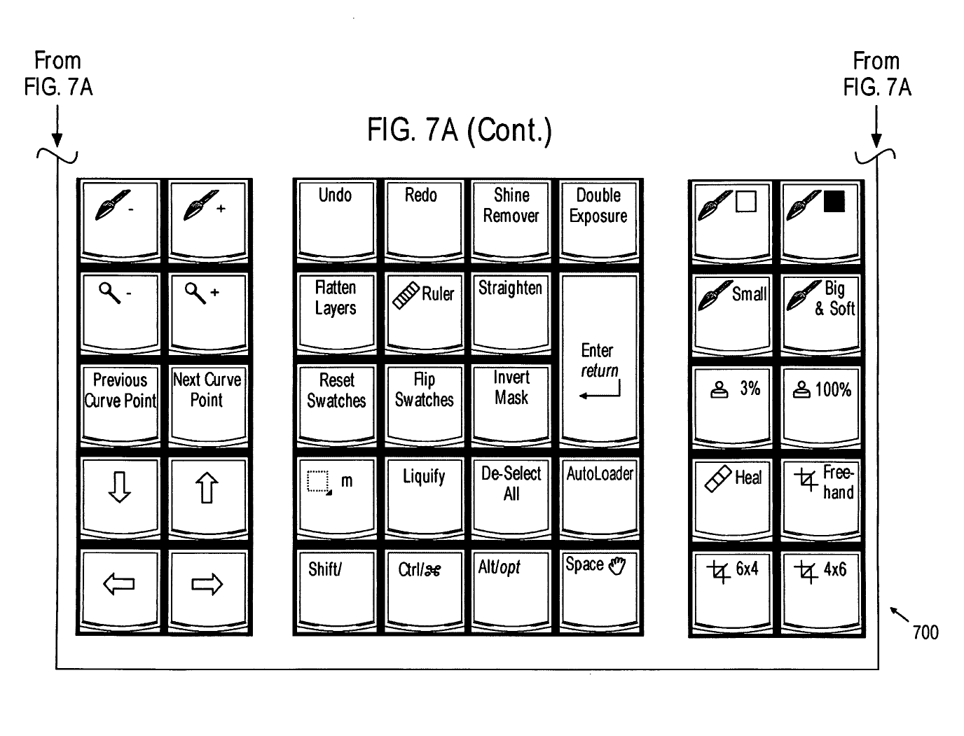

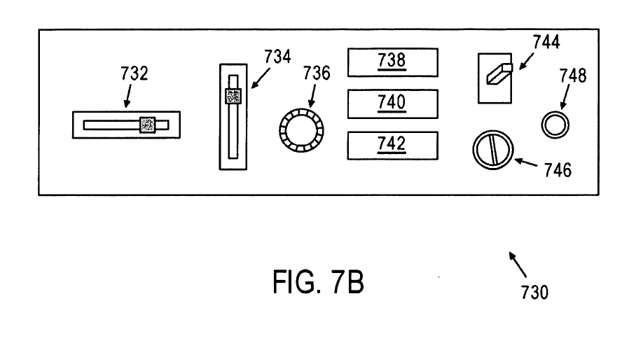

FIG. 7A shows a digital image editing interface 700, according to one embodiment of the invention. A digital image editing interface may be a digital image editing keyboard with one or more of the following human manipulable components: sliders 702, 704, scroll wheel 706, dial 716, cursor controlling device 708, touch screen 710, touch ribbon 712, switch 714, and push button 718. A digital image editing interface may have a different number of keys, different grouping of keys, and different key labels than the one depicted in FIG. 7A.

In a digital image editing interface, a slider may be positioned horizontally like slider 702, vertically like slider 704, or in any orientation on the digital image editing interface. A slider may be used to alter parameters including, but not limited to exposure, contrast, shadow, and highlight detail parameters. Sliding slider 702 to the right may increase (decrease) and to the left may decrease (increase) a parameter's value, respectively. A slider may also be called a fader.

A common scroll wheel can be found on a radio, and is used to tune the radio. In a digital image editing interface, a scroll wheel 706 may be used to alter parameters including, but not limited to exposure, contrast, shadow, and highlight detail parameters. Turning the scroll wheel 706 clockwise may increase (decrease) and counterclockwise may decrease (increase) a parameter's value, respectively.

In a digital image editing interface, a dial 716 may be used to alter parameters including, but not limited to exposure, contrast, shadow, and highlight detail parameters. Twisting the dial 716 clockwise may increase (decrease) and counterclockwise may decrease (increase) a parameter's value, respectively.

A digital image editing interface may include a cursor controlling device 708. In one embodiment, cursor controlling device 708 may be a pen and tablet cursor controlling device.

A digital image editing interface may include a touch screen display 710, such as one commonly found on a copy machine. Touch screen display 710 allows a user to perform the following operations including, but not limited to selecting menus and altering parameter values.

A digital image editing interface may include a touch ribbon 712, or also called a Ribbon Controller. A touch ribbon is similar to a slider, except it has no moving parts. A touch ribbon may be used to alter parameters including, but not limited to exposure, contrast, shadow, and highlight detail parameters. Sliding a finger along the Ribbon Controller in one direction may increase (decrease) and in the other direction may decrease (increase) a parameter's value, respectively.

A digital image editing interface may include a switch 714. A switch may have two or more functional positions. A common two-position switch is a light switch. In a digital image editing interface, a switch may be used to switch the foreground and background colors or recall common tonality settings for exposure, contrasts, shadow, and highlight detail parameters.

A digital image editing interface may include a push button 718. A common pushbutton is a keyboard key, but a push button may include other push buttons, such as a button which remains in a depressed position after being pressed, and returns to a default position, upon a subsequent press. In a digital image editing interface, a push button may be used to toggle the functions of sub-groups of keys, or switch programs and change functions of sub-groups of keys.

FIG. 7B shows a digital image editing interface 730, according to one embodiment of the invention. A digital image editing interface has one or more of the following human manipulable components: sliders 732 734, scroll wheel 736, dial 746, cursor controlling device 738, touch screen 740, touch ribbon 742, switch 744, and push button 748. The human manipulable components are each mapped to a digital image editing operation encoded by at least one digital image editing application macro or script. The human manipulable components that are mapped to digital image editing operations that are related to one another are located adjacent to one another. For example, slider 732 (734) may be used to adjust the horizontal (vertical) position of an anchor point on a tonality curve, and these sliders are positioned adjacent to one another, as depicted in FIG. 7B. The digital image editing interface may be used in a system, as depicted in FIG. 1A, where the digital image editing keyboard 12 has been replaced by a digital image editing interface. The digital image editing interface may be used in a system, as depicted in FIG. 4A-4B, where the digital image editing keyboards 402 and 416 have been replaced by digital image editing interfaces.

This invention minimizes the number of non-artistic operations performed by the user, so the user can focus on free-hand tasks, such as painting changes into masks, which are artistic in nature and difficult to automate. Non-artistic operations include creating new layers; opening, saving, and closing images; resizing and positioning images into placeholders; and configuring tool settings.

The scope of the invention is defined by the following claims and their equivalents.

What is claimed is:

1. A keyboard, comprising a plurality of keys each mapped to a digital image editing operation encoded by at least one of a digital image editing application macro or script, said keys arranged so that (i) those of the keys that are mapped to digital image editing operations that are related to one another are located adjacent to one another, and (ii) the entire plurality of keys is distributed across the keyboard so as to be manipulable by a single, non-dominant hand of a user.

2. The keyboard of claim 1, wherein the digital image editing operation encoded by at least one script includes an operation comprising saving a first image, closing the first image, and opening a second image, all in response to a single keystroke.

3. The keyboard of claim 1, wherein the digital image editing operation encoded by at least one script includes an operation comprising at least one step of re-sizing an image, cropping the image, and positioning the image in a placeholder such that the image does not exceed the placeholder's boundaries, all in response to a single keystroke.

4. The keyboard of claim 1, wherein the digital image editing application is selected from the group consisting of Adobe Photoshop 7, Adobe Photoshop CS2, Adobe Photoshop CS3, Adobe Bridge, Adobe Camera Raw, Phase One's Capture One, and Adobe Lightroom.

5. The keyboard of claim 1, wherein the keyboard further comprises one or more layers of key mappings.

6. The keyboard of claim 5, wherein the keyboard further comprises an indicator indicating an active layer.

7. The keyboard of claim 5, wherein the keyboard further comprises means for selecting an active layer.

8. The keyboard of claim 1, wherein the plurality of keys includes a labeled key that is labeled with a visual aid that describes a digital image editing operations mapped to the labeled key.

9. The keyboard of claim 1, wherein the digital image editing operations that are related to one another comprise operations to move an image, a cursor, or a point horizontally.

10. The keyboard of claim 1, wherein the digital image editing operations that are related to one another comprise operations to move an image, a cursor, or a point vertically.

11. The keyboard of claim 1, wherein the digital image editing operations that are related to one another comprise increasing a brush size and decreasing a brush size.

12. The keyboard of claim 1, wherein the digital image editing operations that are related to one another comprise increasing a magnification level and decreasing a magnification level.

13. The keyboard of claim 1, wherein the digital image editing operations that are related to one another comprise operations to adjust an image's contrast.

14. The keyboard of claim 1, wherein the digital image editing operations that are related to one another comprise operations to select a point on a curve.

15. The keyboard of claim 1, wherein the digital image editing operation comprises creating a new layer, whereby a user can remove or reapply a digital image editing operation.

16. The keyboard of claim 1, further comprising one or more human manipulable components selected from the group consisting of a slider, a scroll wheel, a dial, a cursor controlling device, a touch screen, a touch ribbon, a switch, and a push button.

17. A system, comprising a computing device and a digital image editing keyboard interfaced with the computing device, wherein the keyboard includes a plurality of keys each mapped to a digital image editing operation encoded by at least one of a digital image editing application macro or script, said keys arranged so that (i) those of the keys that are mapped to digital image editing operations that are related to one another are located adjacent to one another, and (ii) the entire plurality of keys is distributed across the keyboard so as to be manipulable by a single, non-dominant hand of a user.

18. The system of claim 17, further comprising a cursor controlling device interfaced with the computing device.

19. The system of claim 18, wherein the cursor controlling device is selected from the group consisting of a computer mouse, joy stick, game controller, touchpad, and pen and tablet.

20. The system of claim 17, further comprising a QWERTY keyboard interfaced with the computing device.

21. The system of claim 17, further comprising a display interfaced with the computing device.

22. The system of claim 17, wherein the computing device is selected from the group consisting of a desktop computer, laptop, workstation, tablet computer, server, handheld device, and mainframe.

23. The system of claim 17, wherein the computing device comprises a repository which stores a mapping of keys on the digital image editing keyboard to digital image editing operations.

24. The system of claim 17, wherein the digital image editing application is selected from the group consisting of Adobe Photoshop 7, Adobe Photoshop CS2, Adobe Photoshop CS3, Adobe Bridge, Adobe Camera Raw, Phase One's Capture One, and Adobe Lightroom.

25. A system, comprising a multi-user computing device and a digital image editing keyboard interfaced with the multi-user computing device, wherein the keyboard includes a plurality of keys each mapped to a digital image editing operation encoded by at least one of a digital image editing application macro or script, said keys arranged so that (i) those of the keys that are mapped to digital image editing operations that are related to one another are located adjacent to one another, and (ii) the entire plurality of keys is distributed across the keyboard so as to be manipulable by a single, non-dominant hand of a user.

26. The system of claim 25, further comprising a cursor controlling device interfaced with the multi-user computing device.

27. The system of claim 26, wherein the cursor controlling device is selected from the group consisting of a computer mouse, joy stick, game controller, touchpad, and pen and tablet.

28. The system of claim 25, further comprising a QWERTY keyboard interfaced with the multi-user computing device.

29. The system of claim 25, further comprising a display interfaced with the multi-user computing device.

30. The system of claim 25, wherein the multi-user computing device is a single computing device, or two or more computing devices interfaced by a communication network.

31. The system of claim 30, wherein the single computing device and two or more computing devices is selected from the group consisting of a desktop computer, laptop, tablet computer, workstation, server, handheld device, and mainframe.

32. The system of claim 30, wherein the communication network is selected from the group consisting of a Local Area Network, Wireless Network, Wide Area Network, and Metropolitan Area Network.

33. The system of claim 25, wherein the multi-user computing device comprises a repository which stores a mapping of keys on the digital image editing keyboard to digital image editing operations.

34. The system of claim 25, wherein the digital image editing application is selected from the group consisting of Adobe Photoshop 7, Adobe Photoshop CS2, Adobe Photoshop CS3, Adobe Bridge, Adobe Camera Raw, Phase One's Capture One, and Adobe Lightroom.

35. A digital image editing interface, comprising a plurality of human manipulable components each mapped to a digital image editing operation encoded by at least one of a digital image editing application macro or script, said human manipulable components arranged so that those of the human manipulable components that are mapped to digital image editing operations that are related to one another are located adjacent to one another.

36. The digital image editing interface of claim 35, wherein the plurality of human manipulable components comprises a scroll wheel.

37. The digital image editing interface of claim 35, wherein the plurality of human manipulable components comprises a touch ribbon.

38. The digital image editing interface of claim 35, wherein the plurality of human manipulable components comprises a slider.

39. The digital image editing interface of claim 35, wherein the plurality of human manipulable components comprises a cursor controlling device.

40. The digital image editing interface of claim 35, wherein the plurality of human manipulable components comprises a touch screen.

41. The digital image editing interface of claim 35, wherein the plurality of human manipulable components comprises a switch.

42. The digital image editing interface of claim 35, wherein the plurality of human manipulable components comprises a dial.

43. The digital image editing interface of claim 35, wherein the plurality of human manipulable components comprises a push button.

44. A system, comprising a computing device and a digital image editing interface interfaced with the computing device, wherein the digital image editing interface includes a plurality of human manipulable components each mapped to a digital image editing operation encoded by at least one of a digital image editing application macro or script, said human manipulable components arranged so that those of the human manipulable components that are mapped to digital image editing operations that are related to one another are located adjacent to one another.

45. The system of claim 44, further comprising a cursor controlling device interfaced with the computing device.

46. The system of claim 45, wherein the cursor controlling device is selected from the group consisting of a computer mouse, joy stick, game controller, touchpad, and pen and tablet.

47. The system of claim 44, further comprising a QWERTY keyboard interfaced with the computing device.

48. The system of claim 44, further comprising a display interfaced with the computing device.

49. The system of claim 44, wherein the computing device is selected from the group consisting of a desktop computer, laptop, workstation, tablet computer, server, handheld device, and mainframe.

50. The system of claim 44, wherein the computing device comprises a repository which stores a mapping of keys on the digital image editing interface to digital image editing operations.

51. The system of claim 44, wherein the digital image editing application is selected from the group consisting of Adobe Photoshop 7, Adobe Photoshop CS2, Adobe Photoshop CS3, Adobe Bridge, Adobe Camera Raw, Phase One's Capture One, and Adobe Lightroom.

52. A system, comprising a multi-user computing device and a digital image editing interface interfaced with the multi-user computing device, wherein the digital image editing interface includes a plurality of human manipulable components each mapped to a digital image editing operation encoded by at least one of a digital image editing application macro or script, said human manipulable components arranged so that those of the human manipulable components that are mapped to digital image editing operations that are related to one another are located adjacent to one another.

53. The system of claim 52, further comprising a cursor controlling device interfaced with the multi-user computing device.

54. The system of claim 53, wherein the cursor controlling device is selected from the group consisting of a computer mouse, joy stick, game controller, touchpad, and pen and tablet.

55. The system of claim 52, further comprising a QWERTY keyboard interfaced with the multi-user computing device.

56. The system of claim 52, further comprising a display interfaced with the multi-user computing device.

57. The system of claim 52, wherein the multi-user computing device is a single computing device, or two or more computing devices interfaced by a communication network.

58. The system of claim 57, wherein the single computing device and two or more computing devices is selected from the group consisting of a desktop computer, laptop, tablet computer, workstation, server, handheld device, and mainframe.

59. The system of claim 57, wherein the communication network is selected from the group consisting of a Local Area Network, Wireless Network, Wide Area Network, and Metropolitan Area Network.

60. The system of claim 52, wherein the multi-user computing device comprises a repository which stores a mapping of keys on the digital image editing interface to digital image editing operations.

61. The system of claim 52, wherein the digital image editing application is selected from the group consisting of Adobe Photoshop 7, Adobe Photoshop CS2, Adobe Photoshop CS3, Adobe Bridge, Adobe Camera Raw, Phase One's Capture One, and Adobe Lightroom.
